(19) United States
(12) Patent Application Publication
(10) Pub. No.: US 2024/0399672 A1
(43) Pub. Date: Dec. 5, 2024

(54) THREE-DIMENSIONAL PRINTING

(71) Applicant: Hewlett-Packard Development Company, L.P., Spring, TX (US)

(72) Inventors: Emre Hiro Discekici, San Diego, CA (US); Shannon Reuben Woodruff, San Diego, CA (US)

(21) Appl. No.: 18/697,694

(22) PCT Filed: Oct. 12, 2021
(86) PCT No.: PCT/US2021/054519

§ 371 Date: Apr. 1, 2024

(51) Int. Cl. B29C 65/48; B29K 77/00; B29K 105/00; B29L 31/50; B33Y 10/00; B33Y 40/20

(52) U.S. Cl. CPC B29C 65/4895; B33Y 40/20; B29K 2077/00; B29K 2105/0032; B29K 2105/0085; B29L 2031/504; B33Y 10/00

(57) ABSTRACT

In an example method, benzyl alcohol is applied to a surface of a first polyamide-based 3D object, a surface of a second polyamide-based 3D object, or both the surface of the firs polyamide-based 3D object and the surface of the second polyamide-based 3D object. Each of the first and second polyamide-based 3D objects is independently selected from the group consisting of a second polyamide 3D object and a polyamide elastomer 3D object. The first polyamide-based 3D object has a different chemical composition than the second polyamide-based 3D object. After the benzyl alcohol is applied, the surface of the first polyamide-based 3D object is directly contacted with the surface of the second polyamide-based 3D object. While the surfaces are in contact, the first polyamide-based 3D object and the second polyamide-based 3D object are exposed to a predetermined temperature for a predetermined time to weld the surfaces together.

### BACKGROUND

Three-dimensional (3D) printing may be an additive printing process used to make three-dimensional solid objects from a digital model. 3D printing is often used in rapid product prototyping, mold generation, mold master generation, and short run manufacturing. Some 3D printing techniques are considered additive processes because they involve the application of successive layers of material (which, in some examples, may include build material, binder and/or other printing liquid(s), or combinations thereof). This is unlike traditional machining processes, which often rely upon the removal of material to create the final object. Some 3D printing methods use chemical binders or adhesives to bind build materials together. Other 3D printing methods involve at least partial coalescence of the build material, and the mechanism for material coalescence (e.g., curing, thermal merging/fusing, melting, sintering, etc.) may depend upon the type of build material used. For some materials, at least partial coalescence may be accomplished using heat-assisted extrusion, and for some other materials (e.g., polymerizable materials), curing or fusing may be accomplished using, for example, infrared light.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating an example of a combined solvent welding and heat treatment process;

FIG. 2 is a flow diagram illustrating an example of a 3D printing method followed by the combined solvent welding and heat treatment process;

FIG. 3 is a schematic illustration of one example of the 3D printing method;

FIG. 4 is a schematic illustration of another example of the 3D printing method;

FIG. 5 is a cross-sectional view of an example 3D printed object;

FIG. 6 is a schematic illustration of an example of combined solvent welding and heat treatment process; and

FIG. 7 is a black and white reproduction of an originally colored photograph of two different polyamide-based 3D objects that had been welded together using the combined solvent welding and heat treatment process disclosed herein.

### DETAILED DESCRIPTION

Some examples of three-dimensional (3D) printing utilize a fusing agent (including an electromagnetic radiation absorber) to pattern polymeric build material, such as polyamide-based build materials. In these examples, an entire layer of the polyamide-based build material is exposed to electromagnetic radiation, but the patterned region (which, in some instances, is less than the entire layer) of the polyamide-based build material is fused/coalesced and hardened to become a layer of a 3D object. In the patterned region, the fusing agent is capable of at least partially penetrating into voids between the build material particles, and is also capable of spreading onto the exterior surface of the build material particles. This fusing agent is capable of absorbing radiation and converting the absorbed radiation to thermal energy, which in turn fuses/coalesces the build material that is in contact with the fusing agent. Fusing/coalescing causes the build material particles to join or blend to form a single entity (i.e., a layer of the 3D object). Fusing/coalescing may involve at least partial thermal merging, melting, binding, and/or some other mechanism that coalesces the polyamide-based build material particles to form the layer of the 3D printed polyamide-based object.

As used herein, the terms “polyamide-based object” and “polyamide-based 3D object” refers to an object that is 3D printed from a polyamide-based build material composition. The polyamide-based build material composition includes a polyamide build material or a polyamide elastomer build material. Polyamide build materials include polymeric particles of polymers that contain amide linkages formed by an amino group of one monomer and a carboxylic group of another monomer or by the ring opening polymerization of a lactam (e.g., butyrolactam, valerolactam, caprolactam, etc.). A 3D object formed of coalesced polyamide build material may be referred to herein as a “polyamide 3D object.” Polyamide elastomer build materials include polymeric particles of block copolymers that contain amides and ethers and/or esters. In polyamide elastomers, the polyamide blocks form hard (thermoplastic) domains, while the polyester, polyether-ester, or polyether blocks form a softer elastomeric matrix. A 3D object formed of coalesced polyamide elastomer build material may be referred to herein as a “polyamide elastomer 3D object.”

In some instances, it may be desirable to adhere the 3D printed polyamide-based object to another polyamide-based object that has a different chemical composition. Because polyamide has high chemical resistance and thus a minimal selection of solubilizing solvents, adhesives are often used for the adhesion of two different polyamide-based objects. Given the chemical resistance, however, it may be difficult to find an adhesive that is chemically compatible, and thus the bond may be relatively weak. Moreover, adhesives may introduce additional issues, including the addition of potential irritants, expansion of desired dimensions, etc.

In the examples disclosed herein, solvent welding and a heat treatment are combined to weld two dissimilar polyamide-based 3D objects together (e.g., two different polyamide 3D objects, two different polyamide elastomer 3D objects, or a polyamide 3D object and a polyamide elastomer 3D object). The combination of the solvent welding and the heat treatment has been found to generate an ultra-strong weld within as little as one minute, depending upon the temperature used. The ultra-strong weld has a bond strength ranging from 25% to 100% of the strength of the weaker polyamide-based material. In one example, the bond strength of the weld ranges from about 5 MPa to about 50 MPa. The solvent used in the combined solvent welding/heat treatment process is benzyl alcohol. The benzyl alcohol and heat may help to solubilize the surface of the polyamide-based object(s). The solubilized surface(s) enable the creation of a weld as opposed to a superficial interfacial bond.

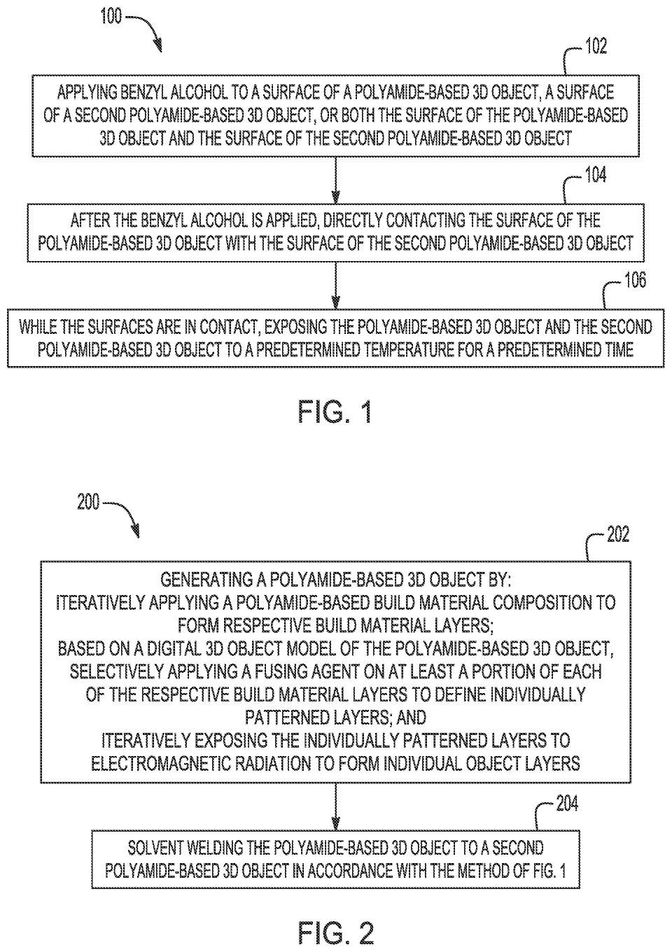

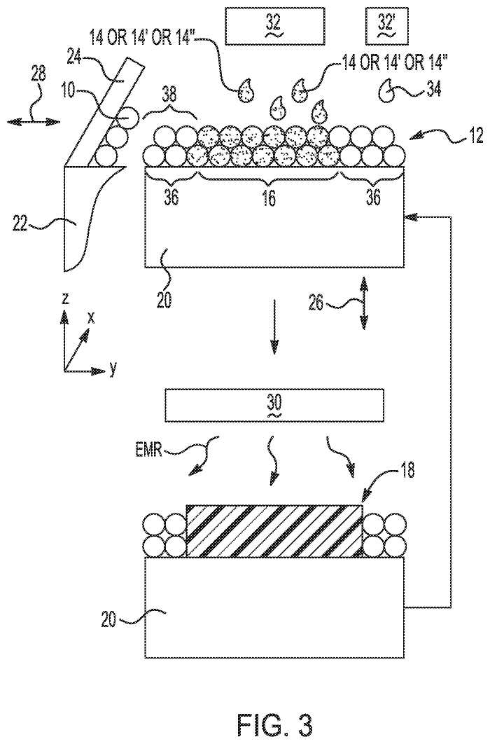

An example of the solvent welding/heat treatment process is shown in FIG. 1. As depicted, the method 100 includes applying benzyl alcohol to a surface of a first polyamide-based 3D object, a surface of a second polyamide-based 3D object, or both the surface of the first polyamide-based 3D object and the surface of the second polyamide-based 3D object (reference numeral 102), wherein each of the first polyamide-based 3D object and the second polyamide-based 3D object is independently selected from the group consisting of a polyamide 3D object and a polyamide elastomer 3D object, and wherein the first polyamide-based 3D object has a different chemical composition than the second polyamide-based 3D object; after the benzyl alcohol is applied, directly contacting the surface of the first polyamide-based 3D object with the surface of the second polyamide-based 3D object (reference numeral 104); and while the surfaces are in contact, exposing the first polyamide-based 3D object and the second polyamide-based 3D object to a predetermined temperature for a predetermined time, thereby welding the surfaces together (reference numeral 106). In this method 100, the first polyamide-based 3D object and/or the second polyamide-based 3D object may be 3D printed using any example of the 3D printing method disclosed herein (described in further detail in reference to FIG. 3 through FIG. 6), or using any other known 3D printing method.

Other examples of the method involve 3D printing one or both of the polyamide-based 3D objects and then welding the objects using the method 100. An example of this method is shown in FIG. 2. As depicted, the method 200 includes generating a polyamide-based 3D object by: iteratively applying a polyamide-based build material composition to form respective build material layers; based on a digital 3D object model of the polyamide-based 3D object, selectively applying a fusing agent on at least a portion of each of the respective build material layers to define individually patterned layers; and iteratively exposing the individually patterned layers to the electromagnetic radiation to form individual object layers (reference numeral 202); and solvent welding the polyamide-based 3D object to a second polyamide-based 3D object in accordance with the method of FIG. 1 (reference numeral 204), which involves applying benzyl alcohol to a surface of the polyamide-based 3D object, a surface of the second polyamide-based 3D object, or both the surface of the polyamide-based 3D object and the surface of the second polyamide-based 3D object, wherein the second polyamide-based 3D object is selected from the group consisting of a second polyamide-based 3D object having a different chemical composition than the polyamide-based 3D object; after the benzyl alcohol is applied, directly contacting the surface of the polyamide-based 3D object with the surface of the second 3D object; and while the surfaces are in contact, exposing the polyamide-based 3D object and the second polyamide-based 3D object to a predetermined temperature for a predetermined time, thereby welding the surfaces together.

Throughout this disclosure, a weight percentage that is referred to as “wt % active” refers to the loading of an active component of a dispersion or other formulation that is present, e.g., in a fusing agent, a detailing agent, etc. For example, an electromagnetic radiation absorber, such as carbon black, may be present in a water-based formulation (e.g., a stock solution or dispersion) before being incorporated into the fusing agent vehicle. In this example, the wt % actives of the carbon black accounts for the loading (as a weight percent) of the carbon black solids that are present in the fusing agent, and does not account for the weight of the other components (e.g., water, etc.) that are present in the stock solution or dispersion with the carbon black.

### Polyamide-based Build Material Compositions

As mentioned, one or both of the 3D objects that are solvent welded together in the method 100 disclosed herein are 3D printed using a polyamide-based build material composition and a fusing agent.

The polyamide-based build material composition includes a polyamide material or a polyamide elastomer material. In some instances, the composition consists of the polyamide material or the polyamide elastomer material, and in other instances, the composition includes the polyamide material or the polyamide elastomer material and one or more additives.

When the 3D object is a polyamide 3D object, the build material composition used in the 3D printing process includes the polyamide material, which is selected from the group consisting of polyamide 12, polyamide 11, polyamide 6, polyamide 8, polyamide 9, polyamide 66, polyamide 612, polyamide 812, and polyamide 912.

Combinations of any of these polyamide materials may also be used.

The polyamide material is crystalline or semi-crystalline, and has a wide processing window of greater than 5° C., which can be defined by the temperature range between the melting point and the re-crystallization temperature. In an example, the polyamide material may have a melting point ranging from about 50° C. to about 300° C. As other examples, the polyamide material may have a melting point ranging from about 155° C. to about 225° C., from about 155° C. to about 215° C., about 160° C. to about 200° C., from about 170° C. to about 190° C., or from about 182° C. to about 189° C. As still another example, the polyamide material may have a melting point of about 180° C.

When the 3D object is a polyamide elastomer 3D object, the build material composition used in the 3D printing process includes the polyamide elastomer material, which is selected from the group consisting of a poly(ester amide) block copolymer, a poly(ether ester amide) block copolymer, and a poly(ether amide) block copolymer. Combinations of any of these polyamide elastomer materials may also be used.

The polyamide elastomer material is amorphous, and has a glass transition temperature at which the material begins to soften. The polyamide elastomer material does not have a melting point, but rather has a range of temperatures over which the elastomer softens. In some examples, this softening temperature range is from about 130° C. to about 250° C.

The build material composition may be a powder or powder-like material, where the polyamide material or the polyamide elastomer material is in the form of solids particles or short fibers. The solid particles may be made up of similarly sized particles and/or differently sized particles. In an example, the average particle size (e.g., average diameter) of the solid particles ranges from about 2 μm to about 225 μm. In some examples, the polyamide material particles or the polyamide elastomer material particles within a distribution of the particles can have a median diameter (D50) ranging from about 10 μm to about 130 μm. In an example, the median value may be weighted by volume, which may be determined using dynamic light scattering (DLS). A ZETASIZER® from Malvern Panalytical is a suitable DLS instrument that may be used. Each of the solid short-fibers has a length that is greater than its width.

The average width of the short fibers may range from about 2 μm to about 225 μm.

The short fibers may, for example, have been cut into short lengths from long strands or threads of the polyamide or polyamide elastomer material.

In some examples, the polyamide-based build material composition does not substantially absorb radiation having a wavelength within the range of 300 nm to 1400 nm. The phrase “does not substantially absorb” means that the absorptivity of the polyamide-based build material composition at a particular wavelength is 25% or less (e.g., 20%, 10%, 5%, etc.)

In some examples, in addition to the polyamide material or the polyamide elastomer material, the build material composition may include other solids, such as an antioxidant, a whitener, an antistatic agent, a flow aid, or a combination thereof.

While several examples of these solid additives are provided, it is to be understood that these solid additives are selected to be thermally stable (i.e., will not decompose) at the 3D printing temperatures.

Antioxidant(s) may be added to the polyamide-based build material composition to prevent or slow molecular weight decreases of the polyamide material or the polyamide elastomer material, and/or to prevent or slow discoloration (e.g., yellowing) by preventing or slowing oxidation of the polyamide material or the polyamide elastomer material. In some examples, the polyamide material or the polyamide elastomer material may discolor upon reacting with oxygen, and this discoloration may contribute to the discoloration of the polyamide-based build material composition. The antioxidant may be selected to minimize discoloration. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polyamide material or the polyamide elastomer material. In an example, the antioxidant may be included in the polyamide-based build material composition in an amount ranging from about 0.01 wt % to about 5 wt %, based on the total weight of the polyamide-based build material composition.

In other examples, the antioxidant may be included in the polyamide-based build material composition in an amount ranging from about 0.01 wt % to about 2 wt % or from about 0.2 wt % to about 1 wt %, based on the total weight of the polyamide-based build material composition.

Whitener(s) may be added to the polyamide-based build material composition to improve visibility. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), boron nitride (BN), and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative). Any example of the whitener may be included in the polyamide-based build material composition in an amount ranging from greater than 0 wt % to about 10 wt %, based on the total weight of the polyamide-based build material composition.

Antistatic agent(s) may be added to the polyamide-based build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the antistatic agent is added in an amount ranging from greater than 0 wt % to less than 5 wt %, based upon the total weight of the polyamide-based build material composition.

Flow aid(s) may be added to improve the coating flowability of the polyamide-based build material composition. Flow aids may be particularly beneficial when the polyamide material particles or the polyamide elastomer particles have an average particle size less than 25 μm. The flow aid improves the flowability of the polyamide-based build material composition by reducing the friction, the lateral drag, and the tribocharge buildup (by increasing the particle conductivity). Examples of suitable flow aids include aluminum oxide (Al₂O₃), tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900). In an example, the flow aid is added in an amount ranging from greater than 0 wt % to less than 5 wt %, based upon the total weight of the polyamide-based build material composition.

### Fusing Agents

A variety of fusing agents may be used in the method disclosed herein, each of which includes a radiation absorbing material. In some examples, the radiation absorbing material exhibits absorption at least at some of the wavelengths within a range of from 100 nm to 4000 nm. Unless stated other, the term “absorption” means that 80% or more of the applied radiation having wavelengths within the specified range is absorbed by the radiation absorbing material. Also unless stated otherwise, the term “transparency” means that 25% or less of the applied radiation having wavelengths within the specified range is absorbed by the radiation absorbing material.

Several example fusing agents will now be described.

### Fusing Agent #1

One example of the fusing agent (fusing agent #1) is referred to herein as a core fusing agent, and the radiation absorbing material in the core fusing agent has absorption at least at wavelengths ranging from 400 nm to 780 nm (e.g., in the visible region). The radiation absorbing material in the core fusing agent may also absorb energy in the infrared region (e.g., 800 nm to 4000 nm). During 3D printing, the absorption of the radiation absorbing material generates heat suitable for coalescing/fusing the build material composition in contact therewith, which leads to 3D printed objects having mechanical integrity and relatively uniform mechanical properties (e.g., strength, elongation at break, etc.). This absorption, however, also results in strongly colored, e.g., dark grey or black, 3D printed objects (or 3D printed object regions).

Examples of the radiation absorbing material in the core fusing agent may be an infrared light absorbing colorant. In an example, the radiation absorbing material is a near-infrared light absorbing colorant. Any near-infrared colorants, e.g., those produced by Fabricolor, Eastman Kodak, or BASF, Yamamoto, may be used in the core fusing agent. As one example, the core fusing agent may be a printing liquid formulation including carbon black as the radiation absorbing material. Examples of this printing liquid formulation are commercially known as CM997A, 516458, C18928, C93848, C93808, or the like, all of which are available from HP Inc.

As another example, the core fusing agent may be a printing liquid formulation including near-infrared absorbing dyes as the radiation absorbing material.

Examples of this printing liquid formulation are described in U.S. Pat. No. 9,133,344, incorporated herein by reference in its entirety. Some examples of the near-infrared absorbing dye are water-soluble near-infrared absorbing dyes selected from the group consisting of:

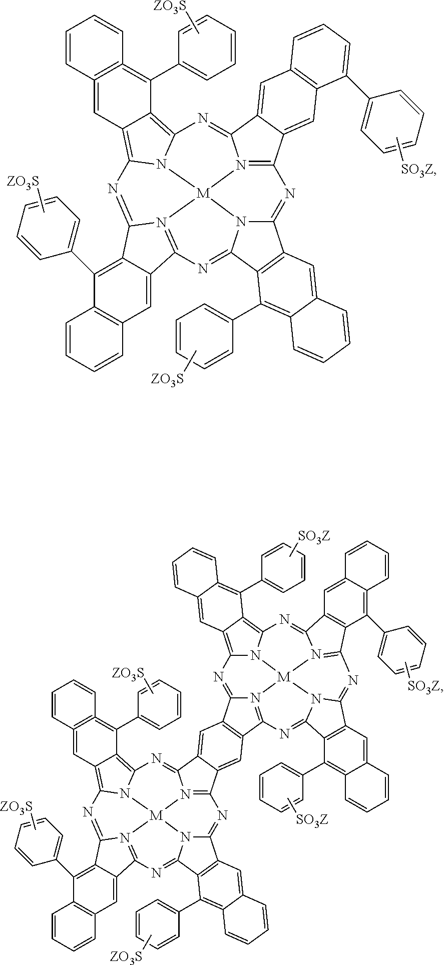

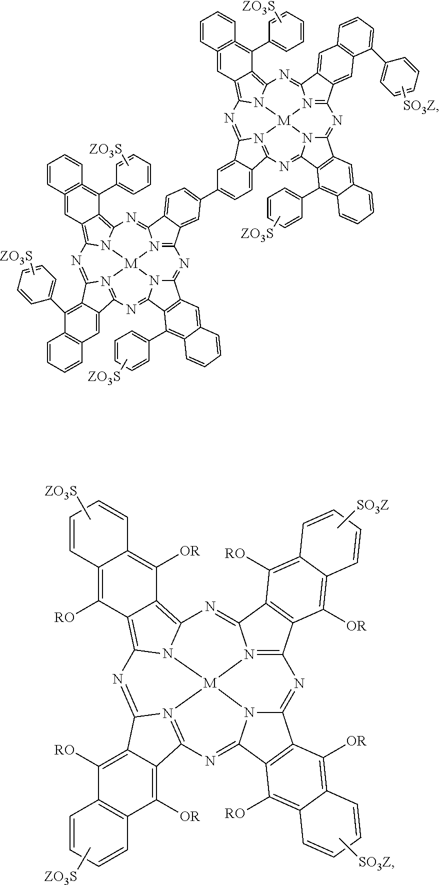

and mixtures thereof. In the above formulations, M can be a divalent metal atom (e.g., copper, etc.) or can have OSO₃Na axial groups filling any unfilled valencies if the metal is more than divalent (e.g., indium, etc.), R can be hydrogen or any C₁-C₈ alkyl group (including substituted alkyl and unsubstituted alkyl), and Z can be a counterion such that the overall charge of the near-infrared absorbing dye is neutral. For example, the counterion can be sodium, lithium, potassium, NH₄⁺, etc.

Some other examples of the near-infrared absorbing dye are hydrophobic near-infrared absorbing dyes selected from the group consisting of:

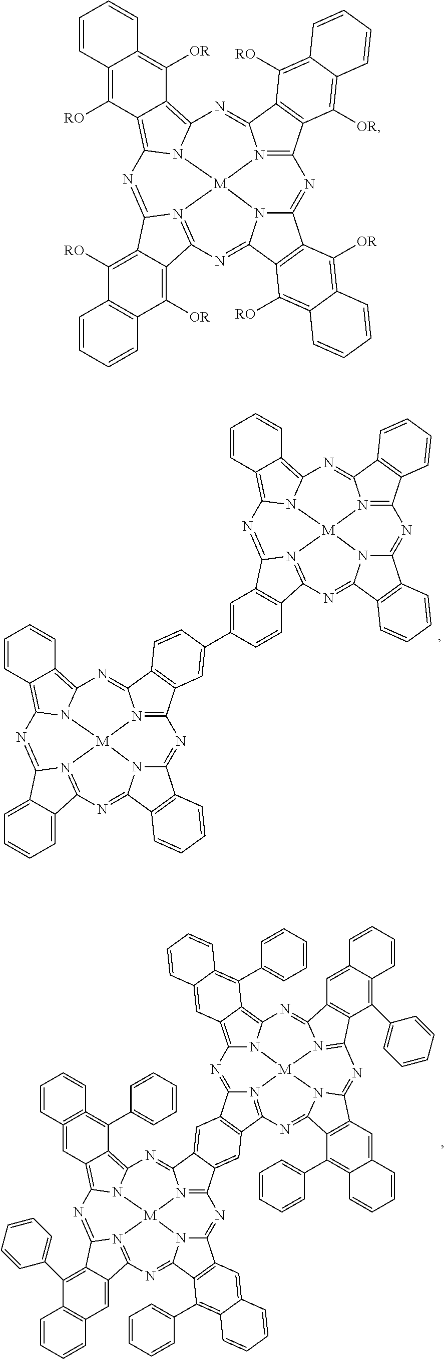

and mixtures thereof. For the hydrophobic near-infrared absorbing dyes, M can be a divalent metal atom (e.g., copper, etc.) or can include a metal that has Cl, Br, or OR′ (R′═H, CH₃, COCH₃, COCH₂COOCH₃, COCH₂COCH₃) axial groups filling any unfilled valencies if the metal is more than divalent, and R can be hydrogen or any C₁-C₈ alkyl group (including substituted alkyl and unsubstituted alkyl).

Other near-infrared absorbing dyes or pigments may be used in the core fusing agent. Some examples include anthraquinone dyes or pigments, metal dithiolene dyes or pigments, cyanine dyes or pigments, perylenediimide dyes or pigments, croconium dyes or pigments, pyrilium or thiopyrilium dyes or pigments, boron-dipyrromethene dyes or pigments, or aza-boron-dipyrromethene dyes or pigments.

Anthraquinone dyes or pigments and metal (e.g., nickel) dithiolene dyes or pigments may have the following structures, respectively:

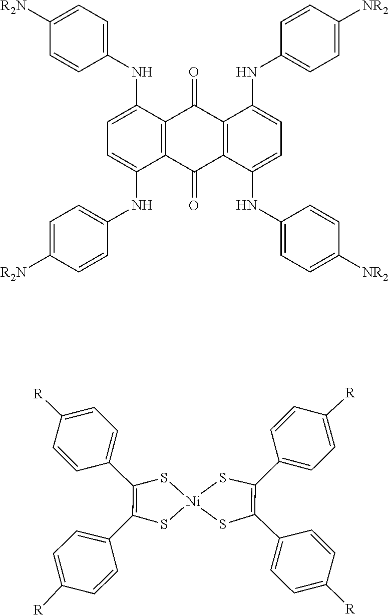

where R in the anthraquinone dyes or pigments may be hydrogen or any C₁-C₈ alkyl group (including substituted alkyl and unsubstituted alkyl), and R in the dithiolene may be hydrogen, COOH, SO₃, NH₂, any C₁-C₈ alkyl group (including substituted alkyl and unsubstituted alkyl), or the like.

Cyanine dyes or pigments and perylenediimide dyes or pigments may have the following structures, respectively:

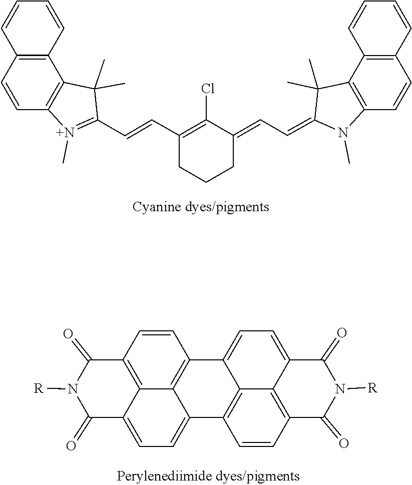

where R in the perylenediimide dyes or pigments may be hydrogen or any C₁-C₈ alkyl group (including substituted alkyl and unsubstituted alkyl).

Croconium dyes or pigments and pyrilium or thiopyrilium dyes or pigments may have the following structures, respectively:

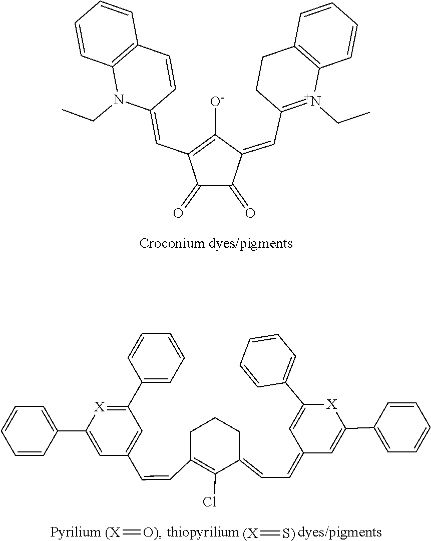

Boron-dipyrromethene dyes or pigments and aza-boron-dipyrromethene dyes or pigments may have the following structures, respectively:

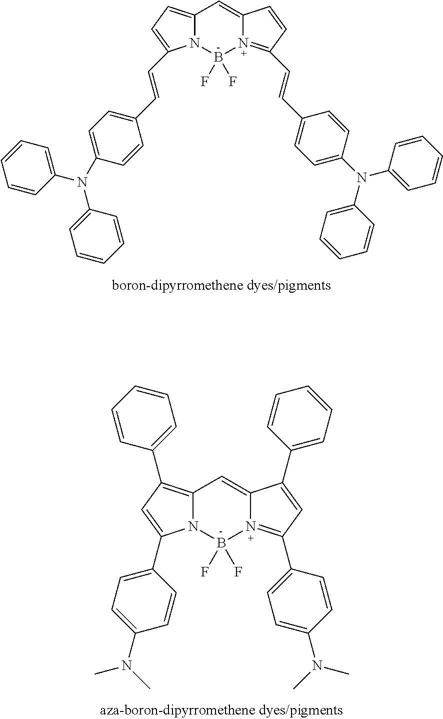

Other suitable near-infrared absorbing dyes may include aminium dyes, tetraaryldiamine dyes, phthalocyanine dyes, and others.

Other near infrared absorbing materials include conjugated polymers (i.e., a polymer that has a backbone with alternating double and single bonds), such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof.

The amount of the radiation absorbing material that is present in the core fusing agent ranges from greater than 0 wt % active to about 40 wt % active based on the total weight of the core fusing agent. In other examples, the amount of the radiation absorbing material in the core fusing agent ranges from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these radiation absorbing material loadings provide a balance between the core fusing agent having jetting reliability and heat and/or radiation absorbance efficiency.

### Fusing Agent #2

Another example of the fusing agent (fusing agent #2) is referred to herein as a primer fusing agent or a low tint fusing agent, and the radiation absorbing material in the primer fusing agent is an absorber having absorption at wavelengths ranging from 100 nm to 400 nm or 800 nm to 4000 nm and having transparency at wavelengths ranging from 400 nm to 780 nm. This absorption and transparency allow the primer fusing agent to absorb enough radiation to coalesce/fuse the build material composition in contact therewith, while enabling the 3D printed objects (or 3D printed regions) to be white or slightly colored.

Some examples of the primer fusing agent are dispersions including the radiation absorbing material that has absorption at wavelengths ranging from 800 nm to 4000 nm and transparency at wavelengths ranging from 400 nm to 780 nm. The absorption of this radiation absorbing material may be the result of plasmonic resonance effects. Electrons associated with the atoms of the radiation absorbing material may be collectively excited by radiation, which results in collective oscillation of the electrons. The wavelengths that can excite and oscillate these electrons collectively are dependent on the number of electrons present in the radiation absorbing material particles, which in turn is dependent on the size of the radiation absorbing material particles. The amount of energy that can collectively oscillate the particle's electrons is low enough that very small particles (e.g., 1 nm to 100 nm) may absorb radiation with wavelengths several times (e.g., from 8 to 800 or more times) the size of the particles. The use of these particles allows the primer fusing agent to be inkjet jettable as well as electromagnetically selective (e.g., having absorption at wavelengths ranging from 800 nm to 4000 nm and transparency at wavelengths ranging from 400 nm to 780 nm).

In an example, the radiation absorbing material of the primer fusing agent has an average particle size (e.g., average diameter) ranging from greater than 0 nm to less than 220 nm. In another example, the radiation absorbing material has an average particle size ranging from greater than 0 nm to 120 nm. In a still another example, the radiation absorbing material has an average particle size ranging from about 10 nm to about 200 nm. In some examples, the radiation absorbing material particles within a distribution of the particles can have a median diameter (D50) ranging from about 50 nm to about 150 nm. In an example, the median value may be weighted by volume, which may be determined using dynamic light scattering (DLS). A ZETASIZER® from Malvern Panalytical is a suitable DLS instrument that may be used.

In an example, the radiation absorbing material of the primer fusing agent is an inorganic pigment. Examples of suitable inorganic pigments include lanthanum hexaboride (LaB₆), tungsten bronzes (AₓWO₃), indium tin oxide (In₂O₃:SnO₂, ITO), antimony tin oxide (Sb₂O₃:SnO₂, ATO), titanium nitride (TiN), aluminum zinc oxide (AZO), ruthenium oxide (RuO₂), iron pyroxenes (AₓFe_{y}Si₂O₆ wherein A is Ca or Mg, x=1.5-1.9, and y=0.1-0.5), modified iron phosphates (AₓFe_{y}PO₄), modified copper phosphates (AₓCu_{y}PO_{z}), and modified copper pyrophosphates (AₓCu_{y}P₂O₇). Tungsten bronzes may be alkali doped tungsten oxides. Examples of suitable alkali dopants (i.e., A in AₓWO₃) may be cesium, sodium, potassium, or rubidium. In an example, the alkali doped tungsten oxide may be doped in an amount ranging from greater than 0 mol % to about 0.33 mol % based on the total mol % of the alkali doped tungsten oxide. Suitable modified iron phosphates (AₓFe_{y}PO) may include copper iron phosphate (A=Cu, x=0.1-0.5, and y=0.5-0.9), magnesium iron phosphate (A=Mg, x=0.1-0.5, and y=0.5-0.9), and zinc iron phosphate (A=Zn, x=0.1-0.5, and y=0.5-0.9). For the modified iron phosphates, it is to be understood that the number of phosphates may change based on the charge balance with the cations. Suitable modified copper pyrophosphates (AₓCu_{y}P₂O₇) include iron copper pyrophosphate (A=Fe, x=0-2, and y=0-2), magnesium copper pyrophosphate (A=Mg, x=0-2, and y=0-2), and zinc copper pyrophosphate (A=Zn, x=0-2, and y=0-2). Combinations of the inorganic pigments may also be used.

The amount of the radiation absorbing material that is present in the primer fusing agent ranges from greater than 0 wt % active to about 40 wt % active based on the total weight of the primer fusing agent. In other examples, the amount of the radiation absorbing material in the primer fusing agent ranges from about 0.3 wt % active to 30 wt % active, from about 1 wt % active to about 20 wt % active, from about 1.0 wt % active up to about 10.0 wt % active, or from greater than 4.0 wt % active up to about 15.0 wt % active. It is believed that these radiation absorbing material loadings provide a balance between the primer fusing agent having jetting reliability and heat and/or radiation absorbance efficiency.

The radiation absorbing material of the primer fusing agent may, in some instances, be dispersed with a dispersant. As such, the dispersant helps to uniformly distribute the radiation absorbing material throughout the primer fusing agent.

Examples of suitable dispersants include polymer or small molecule dispersants, charged groups attached to the radiation absorbing material surface, or other suitable dispersants. Some specific examples of suitable dispersants include a water-soluble acrylic acid polymer (e.g., CARBOSPERSE® K7028 available from Lubrizol), water-soluble styrene-acrylic acid copolymers/resins (e.g., JONCRYL® 296, JONCRYL®671, JONCRYL® 678, JONCRYL® 680, JONCRYL® 683, JONCRYL® 690, etc. available from BASF Corp.), a high molecular weight block copolymer with pigment affinic groups (e.g., DISPERBYK®-190 available BYK Additives and Instruments), or water-soluble styrene-maleic anhydride copolymers/resins.

Whether a single dispersant is used or a combination of dispersants is used, the total amount of dispersant(s) in the primer fusing agent may range from about 10 wt % to about 200 wt % based on the weight of the radiation absorbing material in the primer fusing agent.

A silane coupling agent may also be added to the primer fusing agent to help bond the organic (e.g., dispersant) and inorganic (e.g., pigment) materials.

Examples of suitable silane coupling agents include the SILQUEST® A series manufactured by Momentive.

Whether a single silane coupling agent is used or a combination of silane coupling agents is used, the total amount of silane coupling agent(s) in the primer fusing agent may range from about 0.1 wt % active to about 50 wt % active based on the weight of the radiation absorbing material in the primer fusing agent. In an example, the total amount of silane coupling agent(s) in the primer fusing agent ranges from about 1 wt % active to about 30 wt % active based on the weight of the radiation absorbing material. In another example, the total amount of silane coupling agent(s) in the primer fusing agent ranges from about 2.5 wt % active to about 25 wt % active based on the weight of the radiation absorbing material.

One example of the primer fusing agent includes cesium tungsten oxide (CTO) nanoparticles as the radiation absorbing material. The CTO nanoparticles have a formula of CsₓWO₃, where 0<x<1. The cesium tungsten oxide nanoparticles may give the primer fusing agent a light blue color. The strength of the color may depend, at least in part, on the amount of the CTO nanoparticles in the primer fusing agent.

When it is desirable to form an outer white layer on the 3D printed object, less of the CTO nanoparticles may be used in the primer fusing agent in order to achieve the white color. In an example, the CTO nanoparticles may be present in the primer fusing agent in an amount ranging from about 1 wt % active to about 20 wt % active (based on the total weight of the primer fusing agent).

The average particle size of the CTO nanoparticles may range from about 1 nm to about 40 nm. In some examples, the average particle size of the CTO nanoparticles may range from about 1 nm to about 15 nm or from about 1 nm to about 10 nm. The upper end of the particle size range (e.g., from about 30 nm to about 40 nm) may be less desirable, as these particles may be more difficult to stabilize. Any of these values may also represent the D50 of a particle size distribution.

This example of the primer fusing agent may also include a zwitterionic stabilizer. The zwitterionic stabilizer may improve the stabilization of this example of the primer fusing agent. While the zwitterionic stabilizer has an overall neutral charge, at least one area of the molecule has a positive charge (e.g., amino groups) and at least one other area of the molecule has a negative charge. The CTO nanoparticles may have a slight negative charge. The zwitterionic stabilizer molecules may orient around the slightly negative CTO nanoparticles with the positive area of the zwitterionic stabilizer molecules closest to the CTO nanoparticles and the negative area of the zwitterionic stabilizer molecules furthest away from the CTO nanoparticles.

Then, the negative charge of the negative area of the zwitterionic stabilizer molecules may repel CTO nanoparticles from each other. The zwitterionic stabilizer molecules may form a protective layer around the CTO nanoparticles, and prevent them from coming into direct contact with each other and/or increase the distance between the particle surfaces (e.g., by a distance ranging from about 1 nm to about 2 nm). Thus, the zwitterionic stabilizer may prevent the CTO nanoparticles from agglomerating and/or settling in the primer fusing agent.

Examples of suitable zwitterionic stabilizers include C₂ to C₈ betaines, C₂ to C₈ aminocarboxylic acids having a solubility of at least 10 g in 100 g of water, taurine, and combinations thereof. Examples of the C₂ to C₈ aminocarboxylic acids include beta-alanine, gamma-aminobutyric acid, glycine, and combinations thereof.

The zwitterionic stabilizer may be present in the primer fusing agent in an amount ranging from about 2 wt % active to about 35 wt % active (based on the total weight of the primer fusing agent). When the zwitterionic stabilizer is the C₂ to C₈ betaine, the C₂ to C₈ betaine may be present in an amount ranging from about 8 wt % to about 35 wt % active of the total weight of the primer fusing agent. When the zwitterionic stabilizer is the C₂ to C₈ aminocarboxylic acid, the C₂ to C₈ aminocarboxylic acid may be present in an amount ranging from about 2 wt % active to about 20 wt % active of the total weight of the primer fusing agent. When the zwitterionic stabilizer is taurine, taurine may be present in an amount ranging from about 2 wt % active to about 35 wt % active of the total weight of the primer fusing agent.

In this example, the weight ratio of the CTO nanoparticles to the zwitterionic stabilizer may range from 1:10 to 10:1; or the weight ratio of the CTO nanoparticles to the zwitterionic stabilizer may be 1:1.

### Fusing Agent #3

Still another example of the fusing agent (fusing agent #3) is referred to herein as an ultraviolet (UV) light fusing agent or UV fusing agent, and the radiation absorbing material in the UV fusing agent is a molecule or compound having absorption at wavelengths ranging from 100 nm to 400 nm. These radiation absorbing materials efficiently absorb the UV radiation, convert the absorbed UV radiation to thermal energy, and promote the transfer of the thermal heat to build material composition in order to coalesce the build material composition.

The UV fusing agent can be used with a narrow-band emission source, such as UV light emitting diodes (LEDs), which reduces the band of photon energies to which the non-patterned build material is exposed and thus potentially absorbs. This can lead to more accurate object shapes and reduced rough edges. Some UV radiation absorbing materials are substantially colorless and thus can generate much lighter (e.g., white, off-white, or even translucent) 3D objects than infrared (IR) and/or visible radiation absorbing materials.

Some examples of UV radiation absorbing materials suitable for the UV fusing agent include a B vitamin and/or a B vitamin derivative. Any B vitamins and/or B vitamin derivatives that are water soluble and that have absorption at wavelengths ranging from about 340 nm to about 415 nm may be used in the UV light fusing agent.

As used herein, the phrase “that has absorption at wavelengths ranging from about 340 nm to about 415 nm” means that the B vitamin or B vitamin derivative exhibits maximum absorption at a wavelength within the given range and/or has an absorbance of about 0.1 (about 80% transmittance or less) at one or more wavelengths within the given range. Some of the B vitamins or B vitamin derivatives have lower absorbance. These B vitamins or B vitamin derivatives can still result in suitable coalescence and fusing when they are coupled with a higher intensity and/or a higher dose (where dose=intensity*radiation time).

Examples of suitable B vitamins include riboflavin (vitamin B2), pantothenic acid (vitamin B5), pyridoxine (one form of vitamin B6), pyridoxamine (another form of vitamin B6), biotin (vitamin B7), folic acid (synthetic form of vitamin B9), cyanocobalamin (synthetic form of vitamin B12), and combinations thereof. Examples of suitable B vitamin derivatives include flavin mononucleotide, pyridoxal phosphate hydrate, pyridoxal hydrochloride, pyridoxine hydrochloride, and combinations thereof.

Any combination of one or more B vitamins and one or more B vitamin derivatives may also be used. This may be desirable, for example, when one vitamin or vitamin derivative is less absorbing.

The amount of the B vitamin and/or B vitamin derivative present in the UV light fusing agent will depend, in part, upon its solubility in water and its effect on the jettability of the fusing agent. When the solubility limit of the B vitamin and/or B vitamin derivative is low, the B vitamin and/or B vitamin derivative may be present in an amount ranging from about 1 wt % active to about 5 wt % active of the total weight of the UV light fusing agent. For example, when the B vitamin or the B vitamin derivative is selected from the group consisting of riboflavin (solubility in water 1000 mg/3,000-15,000 mL depending on the crystal structure), folic acid (solubility in water 0.01 mg/mL), cyanocobalamin (solubility in water 1000 mg/80 mL), panthotenic acid (solubility in water 2110 mg/mL), biotin (solubility in water 0.22 mg/mL), pyridoxine (solubility in water ranging from 79 mg/mL to 220 mg/mL), and combinations thereof, the B vitamin or the B vitamin derivative is present in an amount ranging from about 1 wt % active to about 5 wt % active based on a total weight of the UV light fusing agent. When the solubility limit of the B vitamin and/or B vitamin derivative is higher, the B vitamin and/or B vitamin derivative may be present in an amount ranging from about 1 wt % active to about 8 wt % active of the total weight of the fusing agent. For example, when the B vitamin or the B vitamin derivative is selected from the group consisting pyridoxal phosphate hydrate (solubility in water 5.7 mg/mL), pyridoxal hydrochloride (solubility in water 11.7 mg/mL), pyridoxine hydrochloride (solubility in water 200 mg/mL), pyridoxamine (solubility in water 29 mg/mL), and combinations thereof, the B vitamin or the B vitamin derivative may be present in an amount ranging from about 1 wt % active to about 8 wt % active based on a total weight of the UV light fusing agent.

Another example of a suitable UV radiation absorbing material is a functionalized benzophenone. Some of the functionalized benzophenones have absorption at wavelengths ranging from about 340 nm to 405 nm. The phrase “have absorption at wavelengths ranging from about 340 nm to about 405 nm” means that the functionalized benzophenone exhibits maximum absorption at a wavelength within the given range and/or has an absorbance of about 0.1 (about 80% transmittance or less) at one or more wavelengths within the given range.

The functionalized benzophenone is benzophenone substituted with at least one hydrophilic functional group. The functionalization may render the substituted benzophenone more hydrophilic than benzophenone and/or may shift the absorption of the substituted benzophenone to the desired UV range (340 nm to 405 nm). As such, the functionalized benzophenone is a benzophenone derivative including at least one hydrophilic functional group. In some examples, the functionalized benzophenone is benzophenone substituted with one hydrophilic functional group. In other examples, the functionalized benzophenone is benzophenone substituted with two hydrophilic functional groups. In still other examples, the functionalized benzophenone is benzophenone substituted with three hydrophilic functional groups. In the examples where the benzophenone is substituted with multiple functional groups, these groups may be the same or different. Examples of the hydrophilic functional group may be selected from the group consisting of an amine group, a hydroxy group, an alkoxy group, a carboxylic acid group, or a sulfonic acid group.

In examples where the at least one hydrophilic functional group is the amine group, the functionalized benzophenone is selected from the group consisting of

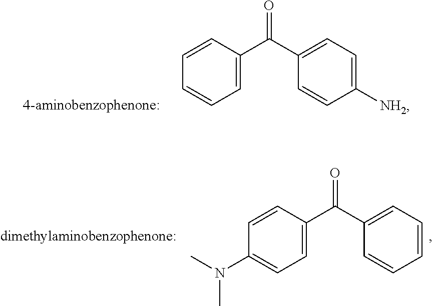 [SMILES: Nc1ccc(C(=O)c2ccccc2)cc1 ; CN(C)c1ccc(C(=O)c2ccccc2)cc1]

and combinations thereof.

In examples where the at least one hydrophilic functional group is the hydroxy group, the functionalized benzophenone is selected from the group consisting are

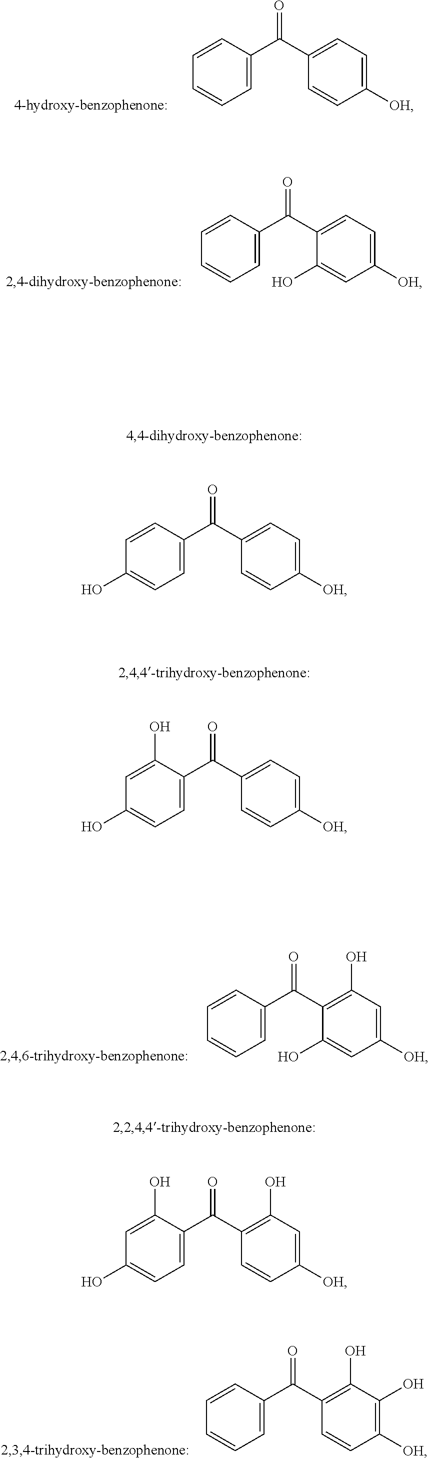

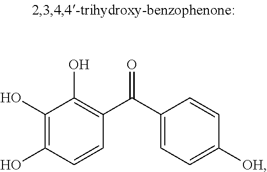 [SMILES: O=C(c1ccc(O)cc1)c1ccc(O)c(O)c1O]

and combinations thereof.

In examples where the at least one hydrophilic functional group is the alkoxy group, the functionalized benzophenone is 4,4′-dimethoxybenophenone:

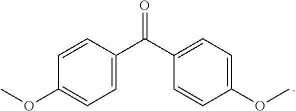

In other examples, the functionalized benzophenone may contain hydrophilic functional groups that are different. In these examples, the functionalized benzophenone is a benzophenone derivative including at least two different hydrophilic functional groups.

In one example, a first hydrophilic functional group of the at least two different hydrophilic functional groups is an alkoxy group, and a second hydrophilic functional group of the at least two different hydrophilic functional groups is a hydroxyl group. Some examples of these functionalized benzophenones include

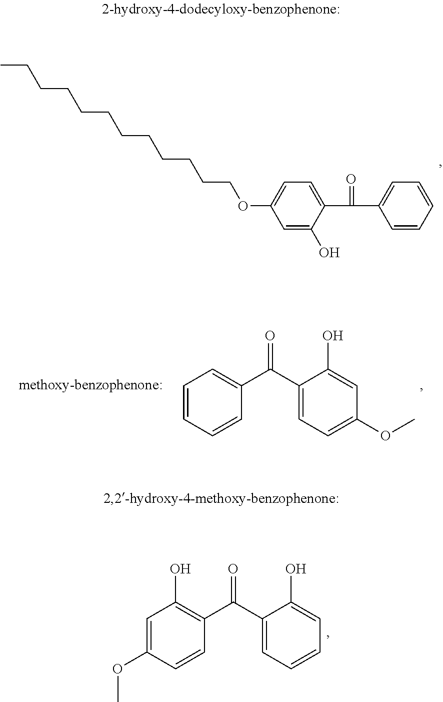 [SMILES: CCCCCCCCCCCCOc1ccc(C(=O)c2ccccc2)c(O)c1 ; COc1ccc(C(=O)c2ccccc2)c(O)c1 ; COc1ccc(C(=O)c2ccccc2O)c(O)c1]

and combinations thereof.

In another example, a first hydrophilic functional group of the at least two different hydrophilic functional groups may be selected from the group consisting of a hydroxy group and a carboxylic acid group, and a second hydrophilic functional group of the at least two different hydrophilic functional groups is an alkyl group. Some examples of these functionalized benzophenones include

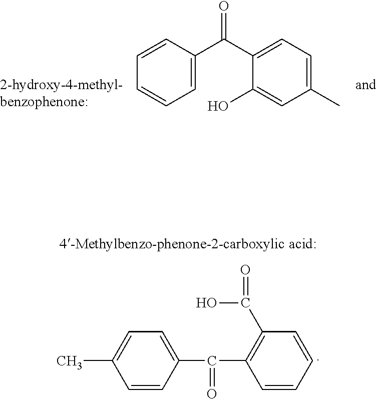

In yet another example, a first hydrophilic functional group of the at least two different hydrophilic functional groups is a hydroxy group, a second hydrophilic functional group of the at least two different hydrophilic functional groups is an alkoxy group, and a third hydrophilic functional group of the at least two different hydrophilic functional groups is a sulfonic acid group. An example of this functionalized benzophenone is 2-hydroxy-4-methoxy-benzophenone-5-sulfonic acid.

Examples of the functionalized benzophenones include 4-hydroxy-benzophenone, 2,4-dihydroxy-benzophenone, 4,4 dihydroxy-benzophenone, 2,4,4′-trihydroxy-benzophenone, 2,4,6 trihydroxy-benzophenone, 2,2′,4,4′-tetrahydroxy-benzophenone, 4,4′-dimethoxybenzophenone, 4-aminobenzophenone, 4-dimethylamino-benzophenone, 2-hydroxy-4-methyl-benzophenone, 4′-methylbenzo-phenone-2-carboxylic acid, 2-hydroxy-4-dodecyloxy-benzophenone, 2-hydroxy-4-methoxy-benzophenone, 2-hydroxy-4-methoxy-benzophenone-5-sulfonic acid, 2,3,4-trihydroxy-benzophenone, 2,3,4,4′-tetrahydroxy-benzophenone, 2,2′-hydroxy-4-methoxy-benzophenone, and combinations thereof.

While several examples of functionalized benzophenones have been provided herein, it is to be understood that any benzophenone substituted with at least one hydrophilic functional group may be used. These may be naturally occurring or synthesized. As examples, benzophenone derivatives with at least one poly(ethylene glycol) (PEG) chain or with at least one phosphocholine chain may be synthesized.

The functionalized benzophenone is at least partially soluble in an aqueous vehicle of the UV light fusing agent. The phrase “at least partially soluble” means that at least 0.5 wt % of the functionalized benzophenone is able to dissolve in the aqueous vehicle.

The amount of the functionalized benzophenone present in the UV light fusing agent will depend, in part, upon its solubility in the aqueous vehicle and its effect on the jettability of the fusing agent. The functionalized benzophenone may be present in an amount ranging from about 0.01 wt % active to about 10 wt % active of the total weight of the fusing agent. When the solubility limit of the functionalized benzophenone in the aqueous vehicle is low (e.g., is less than 5 wt % soluble), the functionalized benzophenone may be present in an amount ranging from about 0.01 wt % active to about 5 wt % active of the total weight of the fusing agent. In an example, the functionalized benzophenone may be present in an amount ranging from about 2 wt % active to about 4 wt % active of the total weight of the fusing agent.

Still another example of a UV radiation absorbing material suitable for use in the UV fusing agent is a plasmonic metal nanoparticle that i) provides absorption enhancement at radiation wavelengths ranging from about 340 nm to about 450 nm, and ii) is present in an amount up to 2 wt % active based on a total weight of the UV light fusing agent.

In an example, the plasmonic metal nanoparticle is selected from the group consisting of silver nanoparticles, gold nanoparticles, copper nanoparticles, aluminum nanoparticles, and combinations thereof. The example plasmonic metal nanoparticles do not merely absorb the UV in the selected range, they exhibit enhanced absorption caused by localized surface plasmon resonance in the near UV and the high photon energy end of visible range (range 340-450 nm). The phrase “absorbs radiation at wavelengths ranging from about 340 nm to about 450 nm” means that the plasmonic metal nanoparticle exhibits maximum absorption at a wavelength within the given range and/or has an absorbance greater than 1 (about 10% transmittance or less) at one or more wavelengths within the given range.

The plasmonic metal nanoparticle may have an average particle size ranging from about 1 nm to about 200 nm. In one example, the plasmonic metal nanoparticle has an average particle size ranging from about 1 nm to about 100 nm.

In another example, the plasmonic metal nanoparticle has an average particle size ranging from about 1 nm to about 50 nm. In some examples, the plasmonic metal nanoparticle within a distribution of the particles can have a median diameter (D50) ranging from about 50 nm to about 150 nm. In an example, the median value may be weighted by volume.

Yet another example of a suitable UV radiation absorbing material is a fluorescent yellow dye having a targeted wavelength of maximum absorption for a 3D print system including the narrow UV-band emission source. The UV light absorber consists of the fluorescent yellow dye, without any other colorant. In particular, it would not be desirable to include any pigment or dye that absorbs other light, or any pigment that could crash out of solution when included with the fluorescent yellow dye.

The fluorescent yellow dye may be pyranine:

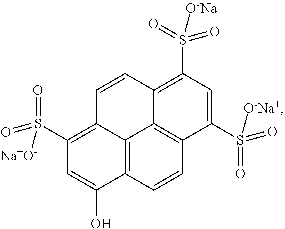

a pyranine derivative, coumarin:

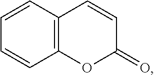 [SMILES: O=c1ccc2ccccc2o1]

a coumarin derivative, a naphthalimide:

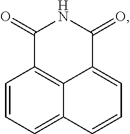 [SMILES: O=C1NC(=O)c2cccc3cccc1c23]

a naphthalimide derivative, a disazomethine derivative: RCH═N—N═CHR, or mixture of these compounds. Some specific examples include Solvent Green 7 (pyranine), Acid Yellow 184 (a coumarin derivative), Acid Yellow 250 (a coumarin derivative), Yellow 101 (Aldazine:

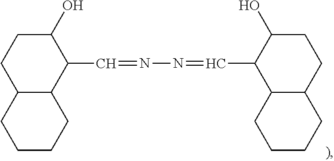 [SMILES: OC1CCC2CCCCC2C1C=NN=CC1C(O)CCC2CCCCC21]

Basic Yellow 40 (a coumarin derivative), Solvent Yellow 43 (a naphthalimide derivative), Solvent Yellow 44 (a naphthalimide derivative), Solvent Yellow 85 (a naphthalimide derivative), Solvent Yellow 145 (a coumarin derivative), Solvent Yellow 160:1 (a coumarin derivative), and combinations thereof.

The fluorescent yellow dye may be present in the UV light fusing agent in an amount ranging from about 1 wt % active to about 10 wt % active, based on a total weight of the UV light fusing agent. In another example, the fluorescent yellow dye may be present in the fusing agent in an amount ranging from about 5 wt % active to about 8 wt % active, or from about 5.5 wt % active to about 7.5 wt % active.

### Fusing Agent Vehicle

Any example of the fusing agent (core fusing agent, primer fusing agent, UV light fusing agent) includes a liquid vehicle. The fusing agent vehicle, or “FA vehicle,” may refer to the liquid in which the radiation absorbing material(s) is/are dispersed or dissolved to form the respective fusing agent. A wide variety of FA vehicles, including aqueous and non-aqueous vehicles, may be used in the fusing agents. In some examples, the FA vehicle may include water alone or a non-aqueous solvent alone, i.e., with no other components. In other examples, the FA vehicle may include other components, depending, in part, upon the applicator that is to be used to dispense the fusing agent. Examples of other suitable fusing agent components include co-solvent(s), humectant(s), surfactant(s), anti-microbial(s), anti-kogation agent(s), chelating agent(s), buffer(s), pH adjuster(s), preservative(s), and/or combinations thereof.

Any water soluble or water miscible organic co-solvent may be used in the fusing agents disclosed herein. Classes of water soluble or water miscible organic co-solvents that may be used in the fusing agents include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols (e.g., 1,2-ethanediol, 1,2-propanediol, etc.), 1,3-alcohols (e.g., 1,3-propanediol), 1,5-alcohols (e.g., 1,5-pentanediol), 1,6-hexanediol or other diols (e.g., 2-methyl-1,3-propanediol, etc.), ethylene glycol alkyl ethers, propylene glycol, propylene glycol alkyl ethers, higher homologs (C₆-C₁₂) of polyethylene glycol alkyl ethers, diethylene glycol, triethylene glycol, tripropylene glycol methyl ether, tetraethylene glycol, glycerol, N-alkyl caprolactams, unsubstituted caprolactams, 2-pyrrolidone, 1-methyl-2-pyrrolidone, 1-(2-hydroxyethyl)-2-pyrrolidone, and the like. Other examples of organic co-solvents include dimethyl sulfoxide (DMSO), isopropyl alcohol, ethanol, pentanol, acetone, or the like.

In aqueous vehicles, the co-solvent(s) may be present in the fusing agent in a total amount ranging from about 1 wt % active to about 20 wt % active based upon the total weight of the fusing agent. In an example, the fusing agent includes from about 2 wt % active to about 15 wt % active, or from about 5 wt % active to about 10 wt % active of the co-solvent(s). In aqueous vehicles, water is present in a higher amount than the co-solvent(s).

In non-aqueous vehicles, the co-solvent(s) may be present in the fusing agent in a total amount ranging from about 50 wt % active to about 90 wt % active based upon the total weight of the fusing agent. In non-aqueous vehicles, the co-solvent is present in a higher amount than water.

The FA vehicle may also include humectant(s). An example of a suitable humectant is ethoxylated glycerin having the following formula:

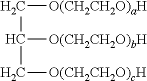

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In an example, the total amount of the humectant(s) present in the fusing agent ranges from about 3 wt % active to about 10 wt % active, based on the total weight of the fusing agent.

The FA vehicle may also include surfactant(s). Suitable surfactant(s) include non-ionic or anionic surfactants. Some example surfactants include alcohol ethoxylates, alcohol ethoxysulfates, acetylenic diols, alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, fluorosurfactants, and the like. Any example of the non-ionic surfactants set forth herein for the anti-microbial agent may be used in the FA vehicle. Some specific examples of anionic surfactants include alkyldiphenyloxide disulfonate (e.g., the DOWFAX™ series, such a 2A1,3B2, 8390, C6L, C10L, and 30599, from The Dow Chemical Company), docusate sodium (i.e., dioctyl sodium sulfosuccinate), sodium dodecyl sulfate (SDS).

Whether a single surfactant is used or a combination of surfactants is used, the total amount of surfactant(s) in the fusing agent may range from about 0.01 wt % active to about 3 wt % active based on the total weight of the fusing agent. In an example, the total amount of surfactant(s) in the fusing agent may be about 1 wt % active based on the total weight of the build material reactive functional agent.

The FA vehicle may also include anti-microbial(s) (i.e., biocide and/or fungicide). Examples of suitable anti-microbials include the NUOSEPT® series (Ashland Inc.), UCARCIDE™ or KORDEK™ or ROCIMA™ (The Dow Chemical Company), the PROXEL® series (Arch Chemicals), ACTICIDE® B20 and ACTICIDE®M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof.

In an example, the total amount of anti-microbial(s) in the fusing agent ranges from about 0.01 wt % active to about 0.05 wt % active (based on the total weight of the fusing agent). In another example, the total amount of anti-microbial(s) in the fusing agent is about 0.04 wt % active (based on the total weight of the fusing agent).

The FA vehicle may also include anti-kogation agent(s). Any example of the anti-kogation agent set forth herein for the anti-microbial agent may be used in the FA vehicle.

The anti-kogation agent may be present in the fusing agent in an amount ranging from about 0.1 wt % active to about 1.5 wt % active, based on the total weight of the fusing agent. In an example, the anti-kogation agent is present in an amount of about 0.5 wt % active, based on the total weight of the fusing agent.

Chelating agents (or sequestering agents) may be included in the FA vehicle to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Whether a single chelating agent is used or a combination of chelating agents is used, the total amount of chelating agent(s) in the fusing agent may range from greater than 0 wt % active to about 0.5 wt % active based on the total weight of the fusing agent. In an example, the chelating agent is present in an amount ranging from about 0.05 wt % active to about 0.2 wt % active based on the total weight of fusing agent. In another example, the chelating agent(s) is/are present in the fusing agent in an amount of about 0.05 wt % active (based on the total weight of the fusing agent).

Some examples of the fusing agent include a buffer. The buffer may be TRIS (tris(hydroxymethyl)aminomethane or TRIZMA®), TRIS or TRIZMA®hydrochloride, bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (p3-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In an example, the total amount of buffer(s) in the fusing agent ranges from about 0.01 wt % to about 3 wt % (based on the total weight of the fusing agent).

Some examples of the fusing agent include a pH adjuster. Suitable pH adjusters may include amino acids or other acids, or sodium bicarbonate or other bases. An example of a suitable amino acid pH adjuster is taurine. The total amount of the pH adjuster(s) in the fusing agent ranges from about 0.01 wt % to about 3 wt % (based on the total weight of the fusing agent).

Some examples of the fusing agent, particularly the UV light fusing agent, include a base as the pH adjuster. In some examples, the B vitamin or the B vitamin derivative is more soluble at a neutral or basic pH. For example, folic acid is more soluble in an aqueous vehicle having a pH greater than 5. As such, it may be desirable to add a base, such as potassium hydroxide, sodium hydroxide, or tetramethylammonium hydroxide, until the desired pH is obtained. In an example, the total amount of the base in the fusing agent ranges from about 0.5 wt % to about 5 wt % (based on the total weight of the fusing agent). In other examples, the amount of base may range from about 0.75 wt % to about 2.5 wt %.

Some examples of the fusing agent include a preservative. Preservatives may be particular suitable when vitamin B or a vitamin B derivative is used as the radiation absorbing material. Examples of suitable preservatives include 2-phenoxyethanol, sodium benzoate, and parabens. In an example, the total amount of the preservative(s) in the fusing agent ranges from about 0.1 wt % to about 3 wt % (based on the total weight of the fusing agent).

The balance of the fusing agent is water (e.g., deionized water, purified water, etc.) or one of the co-solvents. With aqueous or non-aqueous vehicles, the amount of water may vary depending upon the amounts of the other components in the fusing agent. In one example of an aqueous vehicle, the fusing agent is jettable via a thermal inkjet printhead, and includes from about 50 wt % to about 90 wt % water.

In one example of a non-aqueous vehicle, the fusing agent is includes from about 50 wt % to about 86 wt % co-solvent(s) and less than 20 wt % water.

### Detailing Agent

In the examples disclosed herein, a detailing agent may be used in the 3D printing method.

The detailing agent may include a surfactant, a co-solvent, and a balance of water. In some examples, the detailing agent consists of these components, and no other components. In some other examples, the detailing agent may further include a colorant. In still some other examples, the detailing agent consists of a colorant, a surfactant, a co-solvent, and a balance of water, with no other components. In yet some other examples, the detailing agent may further include additional components, such as anti-kogation agent(s), antimicrobial agent(s), and/or chelating agent(s) (each of which is described above in reference to the fusing agent).

The surfactant(s) that may be used in the detailing agent include any of the surfactants listed herein in reference to the fusing agent. The total amount of surfactant(s) in the detailing agent may range from about 0.10 wt % active to about 5.00 wt % active with respect to the total weight of the detailing agent.

The co-solvent(s) that may be used in the detailing agent include any of the co-solvents listed above in reference to the fusing agent. The total amount of co-solvent(s) in the detailing agent may range from about 1 wt % active to about 65 wt % active with respect to the total weight of the detailing agent.

In some examples, the detailing agent does not include a colorant. In these examples, the detailing agent may be colorless. As used herein, “colorless,” means that the detailing agent is achromatic and does not include a colorant.

When the detailing agent includes the colorant, the colorant may be a dye of any color having substantially no absorbance in a range of 650 nm to 2500 nm. By “substantially no absorbance” it is meant that the dye absorbs no radiation having wavelengths in a range of 650 nm to 2500 nm, or that the dye absorbs less than 10% of radiation having wavelengths in a range of 650 nm to 2500 nm. The dye may also be capable of absorbing radiation with wavelengths of 650 nm or less. As such, the dye absorbs at least some wavelengths within the visible spectrum, but absorbs little or no wavelengths within the near-infrared spectrum. This is in contrast to the active (energy absorbing) material in the fusing agent, which absorbs wavelengths within the near-infrared spectrum. As such, the colorant in the detailing agent will not substantially absorb the fusing radiation, and thus will not initiate melting and fusing (coalescence) of the polyamide build material composition in contact therewith when the build material layer is exposed to the energy.

It may be desirable to add color to the detailing agent when the detailing agent is applied to the edge of a colored part. Color in the detailing agent may be desirable when used at a part edge because some of the colorant may become embedded in the polyamide-based build material composition that fuses/coalesces at the edge. As such, in some examples, the dye in the detailing agent may be selected so that its color matches the color of the active material in the fusing agent. As examples, the dye may be any azo dye having sodium or potassium counter ion(s) or any diazo (i.e., double azo) dye having sodium or potassium counter ion(s), where the color of azo or dye azo dye matches the color of the fusing agent.

In an example, the dye is a black dye. Some examples of the black dye include azo dyes having sodium or potassium counter ion(s) and diazo (i.e., double azo) dyes having sodium or potassium counter ion(s). Examples of azo and diazo dyes may include tetrasodium (6Z)-4-acetamido-5-oxo-6-[[7-sulfonato-4-(4-sulfonatophenyl)azo-1-naphthyl]hydrazono]naphthalene-1,7-disulfonate with a chemical structure of:

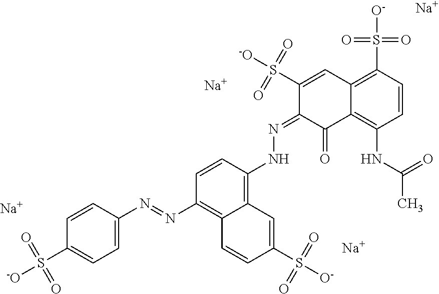

(commercially available as Food Black 1); tetrasodium 6-amino-4-hydroxy-3-[[7-sulfonato-4-[(4-sulfonatophenyl)azo]-1-naphthyl]azo]naphthalene-2,7-disulfonate with a chemical structure of:

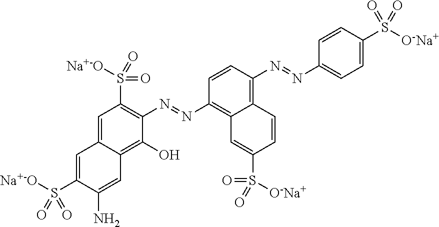

(commercially available as Food Black 2); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

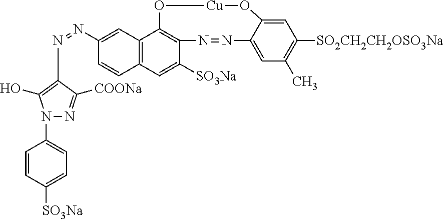

(commercially available as Reactive Black 31); tetrasodium (6E)-4-amino-5-oxo-3-[[4-(2-sulfonatooxyethylsulfonyl)phenyl]diazenyl]-6-[[4-(2-sulfonatooxyethylsulfonyl)phenyl]hydrazinylidene]naphthalene-2,7-disulfonate with a chemical structure of:

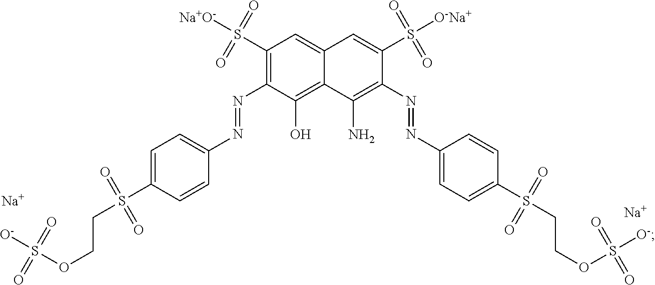

and combinations thereof. Some other commercially available examples of the dye used in the detailing agent include multipurpose black azo-dye based liquids, such as PRO-JET® Fast Black 1 (made available by Fujifilm Holdings), and black azo-dye based liquids with enhanced water fastness, such as PRO-JET® Fast Black 2 (made available by Fujifilm Holdings).

In some instances, in addition to the black dye, the colorant in the detailing agent may further include another dye. In an example, the other dye may be a cyan dye that is used in combination with any of the dyes disclosed herein. The other dye may also have substantially no absorbance above 650 nm. The other dye may be any colored dye that contributes to improving the hue and color uniformity of the final 3D printed polyamide object.

Some examples of the other dye include a salt, such as a sodium salt, an ammonium salt, or a potassium salt. Some specific examples include ethyl-[4-[[4-[ethyl-[(3-sulfophenyl) methyl] amino] phenyl]-(2-sulfophenyl) ethylidene]-1-cyclohexa-2,5-dienylidene]-[(3-sulfophenyl) methyl] azanium with a chemical structure of:

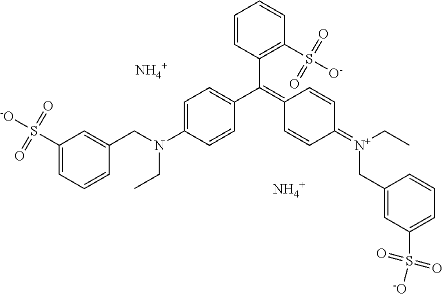

(commercially available as Acid Blue 9, where the counter ion may alternatively be sodium counter ions or potassium counter ions); sodium 4-[(E)-{4-[benzyl(ethyl)amino]phenyl}{(4E)-4-[benzyl(ethyl)iminio]cyclohexa-2,5-dien-1-ylidene}methyl] benzene-1 3-disulfonate with a chemical structure of:

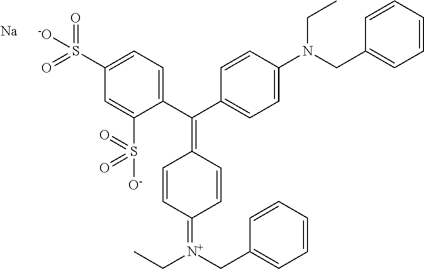

(commercially available as Acid Blue 7); and a phthalocyanine with a chemical structure of:

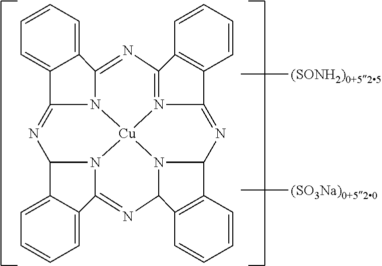

(commercially available as Direct Blue 199), and combinations thereof.

In an example of the detailing agent, the dye may be present in an amount ranging from about 1 wt % active to about 3 wt % active based on the total weight of the detailing agent. In another example of the detailing agent including a combination of dyes, one dye (e.g., the black dye) is present in an amount ranging from about 1.50 wt % active to about 1.75 wt % active based on the total weight of the detailing agent, and the other dye (e.g., the cyan dye) is present in an amount ranging from about 0.25 wt % active to about 0.50 wt % active based on the total weight of the detailing agent.

The balance of the detailing agent is water. As such, the amount of water may vary depending upon the amounts of the other components that are included.

### Coloring Agent

In the examples disclosed herein, a coloring agent may be used in the 3D printing method.

The coloring agent may include a colorant, a co-solvent, and a balance of water. In some examples, the coloring agent consists of these components, and no other components.

In some other examples, the coloring agent may further include a binder and/or a buffer. The binder may be an acrylic latex binder, which may be a copolymer of any two or more of styrene, acrylic acid, methacrylic acid, methyl methacrylate, ethyl methacrylate, and butyl methacrylate. The buffer may be TRIS (tris(hydroxymethyl)aminomethane or TRIZMA®), TRIS or TRIZMA® hydrochloride, bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (p3-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In still other examples, the coloring agent may further include additional components, such as dispersant(s), humectant(s), surfactant(s), anti-kogation agent(s), anti-microbial agent(s), and/or chelating agent(s) (each of which is described herein in reference to the fusing agent).

The coloring agent may be a black agent, a cyan agent, a magenta agent, or a yellow agent. As such, the colorant may be a black colorant, a cyan colorant, a magenta colorant, a yellow colorant, or a combination of colorants that together achieve a black, cyan, magenta, or yellow color.

In some instances, the colorant of the coloring agent may be transparent to infrared wavelengths. In other instances, the colorant of the coloring agent may not be completely transparent to infrared wavelengths, but does not absorb enough radiation to sufficiently heat the polyamide build material composition in contact therewith. In an example, the colorant absorbs less than 10% of radiation having wavelengths in a range of 650 nm to 2500 nm. In another example, the colorant absorbs less than 20% of radiation having wavelengths in a range of 650 nm to 4000 nm.

The colorant of the coloring agent is also capable of absorbing radiation with wavelengths of 650 nm or less. As such, the colorant absorbs at least some wavelengths within the visible spectrum, but absorbs little or no wavelengths within the near-infrared spectrum. This is in contrast to at least some examples of the electromagnetic radiation absorber in the fusing agent, which absorbs wavelengths within the near-infrared spectrum and/or the infrared spectrum. As such, the colorant in the coloring agent will not substantially absorb the fusing radiation, and thus will not initiate coalescing/fusing of the polyamide build material composition in contact therewith when the polyamide build material composition is exposed to energy.

Examples of IR transparent colorants include acid yellow 23 (AY 23), AY17, acid red 52 (AR 52), AR 289, and reactive red 180 (RR 180). Examples of colorants that absorb some visible wavelengths and some IR wavelengths include cyan colorants, such as direct blue 199 (DB 199) and pigment blue 15:3 (PB 15:3).

In other examples, the colorant may be any azo dye having sodium or potassium counter ion(s) or any diazo (i.e., double azo) dye having sodium or potassium counter ion(s), such as those described herein for the detailing agent 16.

An example of the pigment based coloring agent may include from about 1 wt % active to about 10 wt % active of pigment(s), from about 10 wt % active to about 30 wt % active of co-solvent(s), from about 1 wt % active to about 10 wt % active of dispersant(s), from about 0.1 wt % active to about 5 wt % active of binder(s), from 0.01 wt % active to about 1 wt % active of anti-kogation agent(s), from about 0.05 wt % active to about 0.1 wt % active antimicrobial agent(s), and a balance of water. An example of the dye based coloring agent may include from about 1 wt % active to about 7 wt % active of dye(s), from about 10 wt % active to about 30 wt % active of co-solvent(s), from about 1 wt % active to about 7 wt % active of dispersant(s), from about 0.05 wt % active to about 0.1 wt % active antimicrobial agent(s), from 0.05 wt % active to about 0.1 wt % active of chelating agent(s), from about 0.005 wt % active to about 0.2 wt % active of buffer(s), and a balance of water.

Some examples of the coloring agent include a set of cyan, magenta, and yellow agents, such as C1893A (cyan), C1984A (magenta), and C1985A (yellow); or C4801A (cyan), C4802A (magenta), and C4803A (yellow); all of which are available from HP Inc. Other commercially available coloring agents 18 include C9384A (printhead HP 72), C9383A (printhead HP 72), C4901A (printhead HP 940), and C4900A (printhead HP 940).

### 3D Printing Methods

At least one of the two different polyamide-based 3D objects is generated using an example of the 3D printing method disclosed herein. In some instances, both of the polyamide-based 3D objects that are to be welded together using the solvent welding/heat treatment process are generated using an example of the 3D printing method disclosed herein. Different examples of the 3D printing method are shown and described in reference to FIG. 3 through FIG. 6.

Prior to execution of any examples of the method, it is to be understood that a controller may access data stored in a data store pertaining to a 3D part/object that is to be printed. The data may include a digital model of the 3D part/object that is to be built, and additional data, for example, the number of layers of the build material composition that are to be formed, the locations at which any of the agents is/are to be deposited on each of the respective layers, etc. may be derived from this digital 3D object model.

Printing with one Fusing Agent

Referring now to FIG. 3, an example a 3D printing method which utilizes one of the fusing agents is schematically depicted.

The method shown in FIG. 3 includes applying a polyamide-based build material composition 10 to form a build material layer 12; based on a digital 3D object model, selectively applying a fusing agent (e.g., core fusing agent 14, primer fusing agent 14′, UV light fusing agent 14″) onto the build material layer, thereby forming a patterned portion 16; and exposing the build material layer 12 to electromagnetic radiation EMR to selectively coalesce the patterned portion 16 and form a 3D printed object layer 18 composed, at least in part, of coalesced polyamide material or coalesced polyamide elastomer material.

When the 3D printing method is being used to generate the polyamide 3D object, the polyamide-based build material composition 10 includes the polyamide material selected from the group consisting of polyamide 12, polyamide 11, polyamide 6, polyamide 8, polyamide 9, polyamide 66, polyamide 612, polyamide 812, and polyamide 912. When the 3D printing method is being used to generate the polyamide elastomer 3D object, the polyamide-based build material composition 10 includes the polyamide elastomer material selected from the group consisting of a poly(ester amide) block copolymer, a poly(ether ester amide) block copolymer, and a poly(ether amide) block copolymer.

In FIG. 3, the layer 12 of the polyamide-based build material composition 10 is applied on a build area platform 20. A printing system may be used to apply the polyamide-based build material composition 10. The printing system may include the build area platform 20, a build material supply 22 containing the polyamide-based build material composition 10, and a build material distributor 24.

The build area platform 20 receives the polyamide-based build material composition 10 from the build material supply 22. The build area platform 20 may be moved in the directions as denoted by the arrow 26, e.g., along the z-axis, so that the polyamide-based build material composition 10 may be delivered to the build area platform 20 or to a previously formed layer. In an example, when the polyamide-based build material composition 10 is to be delivered, the build area platform 20 may be programmed to advance (e.g., downward) enough so that the build material distributor 24 can push the polyamide-based build material composition 10 onto the build area platform 20 to form a substantially uniform layer 12 of the polyamide-based build material composition 10 thereon. The build area platform 20 may also be returned to its original position, for example, when a new part is to be built.

The build material supply 22 may be a container, bed, or other surface that is to position the polyamide-based build material composition 10 between the build material distributor 24 and the build area platform 20. The build material supply 22 may include heaters so that the polyamide-based build material composition 10 is heated to a supply temperature ranging from about 25° C. to about 150° C. In these examples, the supply temperature may depend, in part, on the polyamide material or polyamide elastomer material in the polyamide-based build material composition 10 used and/or the 3D printer used. As such, the range provided is one example, and higher or lower temperatures may be used.

The build material distributor 24 may be moved in the directions as denoted by the arrow 28, e.g., along the y-axis, over the build material supply 22 and across the build area platform 20 to spread the layer 12 of the polyamide-based build material composition 10 over the build area platform 20. The build material distributor 24 may also be returned to a position adjacent to the build material supply 22 following the spreading of the polyamide-based build material composition 10. The build material distributor 24 may be a blade (e.g., a doctor blade), a roller, a combination of a roller and a blade, and/or any other device capable of spreading the build material composition 10 over the build area platform 20. For instance, the build material distributor 24 may be a counter-rotating roller. In some examples, the build material supply 22 or a portion of the build material supply 22 may translate along with the build material distributor 24 such that polyamide-based build material composition 10 is delivered continuously to the build area platform 20 rather than being supplied from a single location at the side of the printing system as depicted in FIG. 3.

The build material supply 22 may supply the polyamide-based build material composition 10 into a position so that it is ready to be spread onto the build area platform 20. The build material distributor 24 may spread the supplied build material composition 10 onto the build area platform 20. The controller (not shown) may process “control build material supply” data, and in response, control the build material supply 22 to appropriately position the particles of the build material composition 10, and may process “control spreader” data, and in response, control the build material distributor 24 to spread the polyamide-based build material composition 10 over the build area platform 20 to form the layer 12. In FIG. 3, one build material layer 12 has been formed.

The layer 12 has a substantially uniform thickness across the build area platform 20. In an example, the build material layer 12 has a thickness ranging from about 50 μm to about 120 μm. In another example, the thickness of the build material layer 12 ranges from about 30 μm to about 300 μm. It is to be understood that thinner or thicker layers may also be used. For example, the thickness of the build material layer 12 may range from about 20 μm to about 500 μm. The layer thickness may be about 2× (i.e., 2 times) the average particle size (e.g., diameter) of the polyamide material particles or the polyamide elastomer material particles at a minimum for finer part definition. In some examples, the layer thickness may be about 1.2× the average diameter of the polyamide material particles or the polyamide elastomer material particles in the polyamide-based build material composition 10.

After the polyamide-based build material composition 10 has been applied, and prior to further processing, the build material layer 12 may be exposed to heating.

In an example, the heating temperature may be below the melting point or melting range of the polyamide material or the polyamide elastomer material in the build material composition 10. As examples, the pre-heating temperature may range from about 5° C. to about 50° C. below the melting point or the lowest temperature of the melting range of the polyamide material or the polyamide elastomer material. In an example, the pre-heating temperature ranges from about 50° C. to about 205° C. In still another example, the pre-heating temperature ranges from about 100° C. to about 190° C. It is to be understood that the pre-heating temperature may depend, in part, on the build material composition 10 used. As such, the ranges provided are some examples, and higher or lower temperatures may be used.

Pre-heating the layer 12 may be accomplished by using any suitable heat source that exposes all of the polyamide-based build material composition 10 in the layer 12 to the heat. Examples of the heat source include a thermal heat source (e.g., a heater (not shown) integrated into the build area platform 20 (which may include sidewalls)) or a radiation source 30.

After the layer 12 is formed, and in some instances is pre-heated, the fusing agent 14 or 14′ or 14″ is selectively applied on at least some of the polyamide-based build material composition 10 in the layer 12 to form a patterned portion 16.

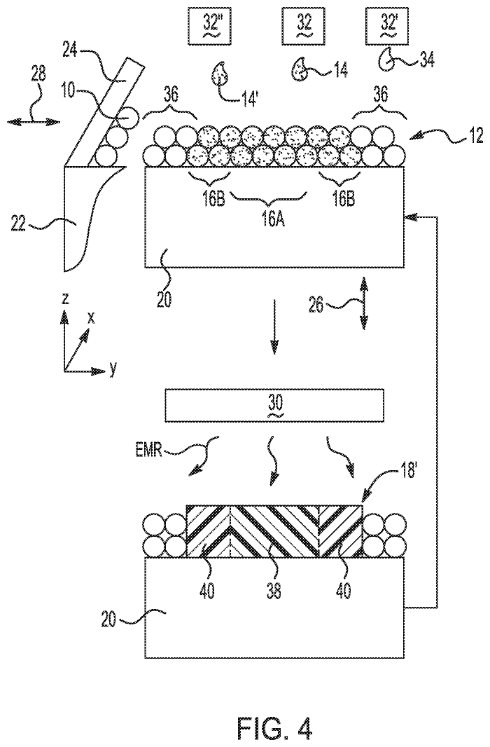

To form a layer 18 of a 3D printed polyamide-based object, at least a portion (e.g., patterned portion 16) of the layer 12 of the build material composition 10 is patterned with the fusing agent 14 or 14′ or 14″. Any of the fusing agents 14 or 14′ or 14″ may be used. When it is desirable to form a white, colored, or slightly tinted object layer 18, the primer fusing agent 14′ or the UV fusing agent 14″ may be used to pattern the polyamide-based build material composition 10. The primer fusing agent 14′ and the UV fusing agent 14″ are clear or slightly tinted, and thus the resulting 3D printed object layer 18 may appear white or the color of the build material composition 10. When it is desirable to form a darker color or black object layer 18, the core fusing agent 14 may be used. The core fusing agent 14 is dark or black, and thus the resulting 3D printed object layer 18 may appear grey, black or another dark color. In other examples of the method (e.g., method shown in FIG. 4) the core and primer fusing agents 14 and 14′ may be used to pattern different portions of a single build material layer 12, which will be described further in reference to FIG. 4. Color may also be added by using the coloring agent (not shown), which will also be described further in reference to FIG. 6.

The volume of the fusing agent 14 or 14′ or 14″ that is applied per unit of the polyamide-based build material composition 10 in the patterned portion 16 may be sufficient to absorb and convert enough electromagnetic radiation so that the polyamide-based build material composition 10 in the patterned portion 16 will coalesce/fuse. The volume of the fusing agent 14 or 14′ or 14″ that is applied per unit of the polyamide-based build material composition 10 may depend, at least in part, on the electromagnetic radiation absorber used, the electromagnetic radiation absorber loading in the fusing agent 14 or 14′ or 14″, and the polyamide material or polyamide elastomer material in the build material composition 10.

The fusing agent 14 or 14′ or 14″ may be dispensed from an applicator 32. The applicator 32 may include a thermal inkjet printhead, a piezoelectric printhead, a continuous inkjet printhead, etc., and the selective application of the fusing agent 14 or 14′ or 14″ may be accomplished by thermal inkjet printing, piezo electric inkjet printing, continuous inkjet printing, etc. The controller may process data, and in response, control the applicator 32 to deposit the fusing agent 14 or 14′ or 14″ onto the predetermined portion(s) 16 of the build material composition 10.

It is to be understood that the selective application of the fusing agent 14 or 14′ or 14″ may be accomplished in a single printing pass or in multiple printing passes. In some examples, the fusing agent 14 or 14′ or 14″ is selectively applied in a single printing pass. In some other examples, the fusing agent 14 or 14′ or 14″ is selectively applied in multiple printing passes. In one of these examples, the number of printing passes ranging from 2 to 4. In still other examples, 2 or 4 printing passes are used. It may be desirable to apply the fusing agent 14 or 14′ or 14″ in multiple printing passes to increase the amount, e.g., of the energy absorber that is applied to the build material composition 10, to avoid liquid splashing, to avoid displacement of the build material composition 10, etc.

In the example shown in FIG. 3, the detailing agent 34 is also selectively applied to the portion(s) 36 of the layer 12. The portion(s) 36 are not patterned with the fusing agent 14 or 14′ or 14″ and thus are not to become part of the final 3D printed object layer 18. Thermal energy generated during radiation exposure may propagate into the surrounding portion(s) 36 that do not have the fusing agent 14 or 14′ or 14″ applied thereto. The propagation of thermal energy may be inhibited, and thus the coalescence of the non-patterned build material portion(s) 36 may be prevented, when the detailing agent 34 is applied to these portion(s) 36.

The detailing agent 34 may also be dispensed from an applicator 32′. The applicator 32′ may include any of the inkjet printheads set forth herein. It is to be understood that the applicators 32, 32′ may be separate applicators or may be a single applicator with several individual cartridges for dispensing the respective agents 14 or 14′ or 14″ and 34. The detailing agent 34 may also be selectively applied in a single printing pass or in multiple printing passes.

After the agents 14 or 14′ or 14″ and 34 are selectively applied in the specific portion(s) 16 and 36 of the layer 12, the entire layer 12 of the polyamide-based build material composition 10 is exposed to electromagnetic radiation (shown as EMR in FIG. 3).

The electromagnetic radiation is emitted from the radiation source 30. The radiation source 30 may be an infrared light source, an ultraviolet light source, or any other suitable source of radiation that can be absorbed by the fusing agent 14 or 14′ or 14″ being used.

The length of time the electromagnetic radiation is applied for, or energy exposure time, may be dependent, for example, on one or more of: characteristics of the radiation source 30; characteristics of the polyamide-based build material composition 10; and/or characteristics of the fusing agent 14 or 14′ or 14″.

It is to be understood that the electromagnetic radiation exposure may be accomplished in a single radiation event or in multiple radiation events. In an example, the exposing of the polyamide-based build material composition 10 is accomplished in multiple radiation events. In a specific example, the number of radiation events ranges from 3 to 8. In still another specific example, the exposure of the polyamide-based build material composition 10 to electromagnetic radiation may be accomplished in 3 radiation events. It may be desirable to expose the polyamide-based build material composition 10 to electromagnetic radiation in multiple radiation events to counteract a cooling effect that may be brought on by the amount of the agents 14 or 14′ and 34 that is applied to the build material layer 12. Additionally, it may be desirable to expose the polyamide-based build material composition 10 to electromagnetic radiation in multiple radiation events to sufficiently elevate the temperature of the build material composition 10 in the portion(s) 16, 36, without over heating the build material composition 10 in the non-patterned portion(s) 36.

The fusing agent 14 or 14′ or 14″ enhances the absorption of the radiation, converts the absorbed radiation to thermal energy, and promotes the transfer of the thermal heat to the build material composition 10 in contact therewith. In an example, the fusing agent 14 or 14′ or 14″ sufficiently elevates the temperature of the build material composition 10 in the portion 16 to a temperature above the melting point or within the melting range of the polyamide material or the polyamide elastomer material, allowing coalescing/fusing (e.g., thermal merging, melting, binding, etc.) of the build material composition 10 to take place. The application of the electromagnetic radiation forms the 3D printed object layer 18.

In some examples, the electromagnetic radiation has a wavelength ranging from 800 nm to 4000 nm, or from 800 nm to 1400 nm, or from 800 nm to 1200 nm. Radiation having wavelengths within the provided ranges may be absorbed (e.g., 80% or more of the applied radiation is absorbed) by the fusing agent 14 or 14′ and may heat the polyamide-based build material composition 10 in contact therewith, and may not be substantially absorbed (e.g., 25% or less of the applied radiation is absorbed) by the non-patterned build material composition 10 in portion(s) 36.

After the 3D printed object layer 18 is formed, additional layer(s) may be formed thereon to create an example of the 3D printed polyamide-based object. To form the next layer, additional polyamide-based build material composition 10 may be applied on the layer 18. The fusing agent 14 or 14′ or 14″ is then selectively applied on at least a portion of the additional build material composition 10, according to the digital 3D object model. The detailing agent 34 may be applied in any area of the additional build material composition 10 where coalescence is not desirable. After the agent(s) 14 or 14′ or 14″ and 34 is/are applied, the entire layer of the additional build material composition 10 is exposed to electromagnetic radiation in the manner described herein. The application of additional polyamide-based build material composition 10, the selective application of the agent(s) 14 or 14′ or 14′ and 34, and the electromagnetic radiation exposure may be repeated a predetermined number of cycles to form the final 3D printed polyamide object in accordance with the 3D object model.

Printing with Two Fusing Agents

Referring now to FIG. 4, an example of the 3D printing method utilizing both the core and primer fusing agents 14 and 14′ is depicted.

The method shown in FIG. 4 includes applying a polyamide-based build material composition 10 to form a build material layer 12; based on a digital 3D object model, selectively applying a core fusing agent 14 onto the build material layer 12, thereby forming a first patterned portion 16A; based on the digital 3D object model, selectively applying a primer fusing agent 14′ onto the build material layer 12, thereby forming a second patterned portion 16B adjacent to the first patterned portion 16A; and exposing the build material layer 12 to electromagnetic radiation EMR to selectively coalesce the patterned portions 16A and 16B and form a 3D printed object layer 18′.

In FIG. 4, one layer 12 of the polyamide-based build material composition 10 is applied on the build area platform 20 as described in reference to FIG. 3. After the polyamide-based build material composition 10 has been applied, and prior to further processing, the build material layer 12 may be exposed to pre-heating as described in reference to FIG. 3.

In this example of the 3D printing method, the core fusing agent 14 is selectively applied on at least some of the polyamide-based build material composition 10 in the layer 12 to form a first patterned portion 16A; and the primer fusing agent(s) 14′ is selectively applied on at least some of the polyamide-based build material composition 10 in the layer 12 to form second patterned portion(s) 16B that is/are adjacent to the first patterned portion(s) 16A. In one example, the first patterned portion 16A (patterned with the core fusing agent 14) may be located at an interior portion of the build material layer 12 to impart mechanical strength, and the second patterned portion 16B (patterned with the primer fusing agent 14′) may be located at an exterior portion of the build material layer 12 to mask the color of the first patterned portion 16A.

The volume of the core fusing agent 14 that is applied per unit of the polyamide-based build material composition 10 in the first patterned portion 16A may be sufficient to absorb and convert enough electromagnetic radiation so that the build material composition 10 in the patterned portion 16A will coalesce/fuse.

The volume of the primer fusing agent 14′ that is applied per unit of the polyamide-based build material composition 10 in the second patterned portion 16B may be sufficient to absorb and convert enough electromagnetic radiation so that the polyamide-based build material composition 10 in the second patterned portion 16B will coalesce/fuse.

In the example shown in FIG. 4, the detailing agent 34 is also selectively applied to the portion(s) 36 of the layer 12. The portion(s) 36 are not patterned with the fusing agent 14 or 14′ and thus are not to become part of the final 3D printed object layer 18′.

After the agents 14, 14′, and 34 are selectively applied in the specific portion(s) 16A, 16B, and 36 of the layer 12, the entire layer 12 of the build material composition 10 is exposed to electromagnetic radiation (shown as EMR in FIG. 4).

Radiation exposure may be accomplished as described in reference to FIG. 3.

In this example, the respective fusing agents 14 and 14′ enhance the absorption of the radiation, convert the absorbed radiation to thermal energy, and promote the transfer of the thermal heat to the build material composition 10 in contact therewith. In an example, the fusing agents 14 and 14′ sufficiently elevate the temperature of the build material composition 10 in the respective portions 16A, 16B to a temperature above the melting point or within the melting range of the polyamide material or polyamide elastomer material, allowing coalescing/fusing (e.g., thermal merging, melting, binding, etc.) of the polyamide-based build material composition 10 to take place. The application of the electromagnetic radiation forms the 3D printed object layer 18′, which, in this example, includes a core portion 38 and primer portions 40 at opposed ends of the core portion 38.

FIG. 4 illustrates one example of how the core fusing agent 14 and the primer fusing agent 14′ may be used together to pattern a single build material layer 12.

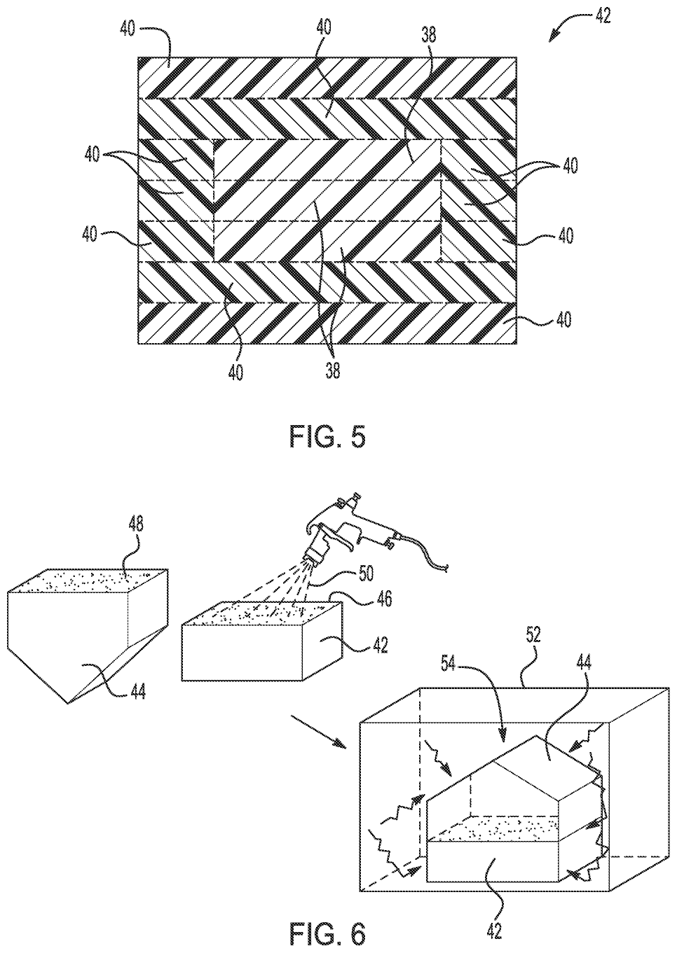

FIG. 5 illustrates another example of how the core fusing agent 14 and the primer fusing agent 14′ may be used to pattern several build material layers to form an example 3D printed polyamide or polyamide elastomer object 42. In this example, the core fusing agent 14 is utilized to form the core (e.g., the center or inner-most portion) of the 3D printed polyamide or polyamide elastomer object 42, and the primer fusing agent 14′ is used to form the outermost layers of the 3D printed polyamide or polyamide elastomer object 42. The core fusing agent 14 can impart strength to the core of the 3D printed polyamide or polyamide elastomer object 42, while the primer fusing agent 14′ enables white or a color to be exhibited at the exterior of the 3D printed polyamide or polyamide elastomer object 42.

To form this example of the 3D printed polyamide or polyamide elastomer object 42, the outermost build material layer(s) and the outermost edges of the middle build material layers would be patterned with the primer fusing agent 14′ to form primer portions 40 of the 3D printed polyamide or polyamide elastomer object 42. The innermost portions of the middle build material layers would be patterned with the core fusing agent 14 to form the core portions 38 of the 3D printed polyamide or polyamide elastomer object 42. In this example, any number of core portions 38 may be formed, and any number of primer portions 40 may be formed.

In any of the example 3D printing methods, the coloring agent (not shown) may also be applied with the primer fusing agent 14′ to generate color at the exterior surfaces of the 3D printed object, such as object 42. For example, the coloring agent may be applied with the primer fusing agent 14′ on the portions of the build material layers that form the primer portions 40. Since the primer fusing agent 14′ is clear or slightly tinted and the polyamide-based build material composition 10 is white or off-white, the color of the coloring agent will be the color of the resulting primer portions 40. The colorant of the coloring agent becomes embedded throughout the coalesced/fused build material composition of the primer portions 40.

When core and primer portions 38, 40 are formed and the coloring agent is used, it is to be understood that some of the primer portions 40 directly adjacent to the core portions 38 may be left uncolored. In this example, the uncolored primer portions 40 are white or slightly tinted, and may function as intermediate layers that help to form a mask over the black (or dark colored) core layers 38. The presence of uncolored primer portions 40 between core portions 38 and primer portions 40 that are colored with the coloring agent may help to optically isolate the core layers 38.

In other examples of the method, the coloring agent may also be applied with the UV fusing agent 14″ to generate color at any desirable portion of the 3D printed object. In these instances, the colorant of the coloring agent becomes embedded throughout the coalesced/fused build material composition of the portion(s) patterned with both the UV fusing agent 14″ and the coloring agent. Since the UV fusing agent 14″ is clear or slightly tinted and the polyamide-based build material composition 10 is white or off-white, the desirable portion(s) of the 3D printed object will exhibit the color of the coloring agent.

Additionally, in the examples disclosed herein, the 3D printed polyamide or polyamide elastomer object 42 may be printed in any orientation with respect to the X-Y plane of the build area platform 20, and thus with respect to the layers 12 of the build material composition 10. For example, the 3D printed polyamide or polyamide elastomer object 42 can be printed from bottom to top in the Z-direction, or at an inverted orientation (e.g., from top to bottom) in the Z-direction. For another example, the 3D printed polyamide or polyamide elastomer object 42 can be printed at an angle or on its side. The orientation of the build within the build material composition 10 can be selected in advance or even by the user at the time of printing, for example.

### Solvent Welding/Heat Treatment Process

The 3D printed polyamide or polyamide elastomer object 42 may then be welded to another (a second) 3D printed object using an example of the solvent welding/heat treatment process disclosed herein. An example is schematically shown in FIG. 6, wherein the 3D printed polyamide or polyamide elastomer object 42 is welded to another 3D printed object 44. The 3D printed polyamide or polyamide elastomer object 42 has a different chemical composition than the second 3D printed object 44.

In one example, the first polyamide-based 3D object 42 is the polyamide 3D object; the polyamide 3D object includes a coalesced polyamide material selected from the group consisting of polyamide 12, polyamide 11, polyamide 6, polyamide 8, polyamide 9, polyamide 66, polyamide 612, polyamide 812, and polyamide 912; the second polyamide-based 3D object 44 is the polyamide elastomer 3D object; and the polyamide elastomer 3D object (second 3D object 44) includes a coalesced polyamide elastomer material selected from the group consisting of a poly(ester amide) block copolymer, a poly(ether ester amide) block copolymer, and a poly(ether amide) block copolymer. In this example, the polyamide 3D object is to be solvent welded to the polyamide elastomer 3D object.

In another example, the first polyamide-based 3D object 42 is the polyamide 3D object; the polyamide 3D object includes polyamide 12; the second 3D object 44 is the second polyamide 3D object; and the second polyamide 3D object (second 3D object 44) includes a coalesced polyamide material selected from the group consisting of polyamide 11, polyamide 6, polyamide 8, polyamide 9, polyamide 66, polyamide 612, polyamide 812, and polyamide 912. In this example, one of the 3D objects 42, 44 includes coalesced polyamide 12. It is to be understood that the 3D objects 42, 44 may independently be any of the polyamide materials disclosed herein, as long as they have different chemical compositions (e.g., one is polyamide 11 and the other is polyamide 66, one is polyamide 8 and the other is polyamide 612, etc.). In this example, two different polyamide 3D objects are to be solvent welded together.

In still another example, the first polyamide-based 3D object 42 is the polyamide elastomer 3D object; the polyamide elastomer 3D object includes a coalesced polyamide elastomer material selected from the group consisting of a poly(ester amide) block copolymer, a poly(ether ester amide) block copolymer, and a poly(ether amide) block copolymer; the second polyamide-based 3D object 44 is a second polyamide elastomer 3D object; and the second polyamide elastomer 3D object 44 includes a coalesced polyamide elastomer material that is different from the coalesced polyamide elastomer material polyamide elastomer 3D object 42. In this example, two different polyamide elastomer 3D objects are to be solvent welded together.

Prior to the solvent welding/heat treatment process, one or both of the 3D printed polyamide or polyamide elastomer objects 42, 44 is/are generated using any example of the 3D printing method, and is removed from the build area platform 20.

Excess (non-coalesced) polyamide-based build material composition 10 may be removed from the 3D printed objects 42, 44.

The solvent welding/heat treatment process is initiated by applying benzyl alcohol 50 to a surface 46 of the first polyamide-based 3D object 42, a surface 48 of the second polyamide-based 3D object 44, or both the surface 46 of the first polyamide-based 3D object 42 and the surface 48 of the second polyamide-based 3D object 44. The surface(s) 46, 48 are the surfaces 46, 48 of the respective objects 42, 44 that are to be welded together. As shown in FIG. 6, in one example, both surfaces 46, 48 have the benzyl alcohol 50 applied thereto.

Benzyl alcohol 50 is an aromatic alcohol with the formula C₆HSCH₂OH. In one example, the benzyl alcohol 50 is anhydrous (99.8%) benzyl alcohol. In another example, the benzyl alcohol 50 is 99.0% benzyl alcohol.

The benzyl alcohol 50 may be applied to the surface(s) 46, 48 using any suitable deposition technique, such as brushing, dripping, or spraying. A spray gun is shown in FIG. 6. These processes expose the desired surface(s) 46, 48 to a relatively gentle solvent that can coat the exterior surface(s) 46, 48 and also penetrate into pores at exterior surface(s) 46, 48.

The deposition process generates a thin layer of the benzyl alcohol 50 on the desired surface(s) 46, 48. The thickness of this thin layer may range from about 50 μm to about 500 μm. The thickness of the thin layer may not directly correspond with the amount deposited because some of the benzyl alcohol 50 penetrates into pores at exterior surface(s) 46, 48.

After the benzyl alcohol 50 is applied to the desired surface(s) 46, 48, the surface 46 of the first polyamide-based 3D object 42 is placed into direct contact with the surface 48 of the second polyamide-based 3D object 44. This may be done manually or via an automated process.

While the surfaces 46, 48 are in contact, the polyamide-based 3D object 42 and the second polyamide-based 3D object 44 are exposed to a predetermined temperature for a predetermined time to weld the surfaces 46, 48 together. The combination of the solvent and the heat generate a weld.

The predetermined temperature and time for heating are sufficient to initiate melting at the surfaces 46, 48 of the 3D objects 42, 44 and avoid melting of a bulk of the 3D objects 42, 44.

The predetermined temperature is below a melting temperature (i.e., a melting point or a lowest temperature of a melting range) of each of the first polyamide-based 3D object 42 and the second polyamide-based 3D object 44. In an example, the predetermined temperature ranges from about 50° C. to about 150° C.

The predetermined time ranges from about 1 minute to about 24 hours. The time for heating depends, in part, upon the geometry of the objects, the amount of benzyl alcohol 50 applied, and the heating mechanism that is used. In an example, the method includes determining the predetermined time based on a geometry of each of the first polyamide-based 3D object and the second polyamide-based 3D object.

Larger objects and/or objects with more complex geometries may involve longer heating times. Additionally, when lower temperatures are used, longer heating times may be desirable.

Heating may be performed in an oven, using a heat lamp or hot plate, or using any other suitable heating device 52.

The combination of heat and benzyl alcohol 50 present at the interface of the contacted surfaces 46, 48, and in some instances penetrated into a portion of the depth of the 3D objects 42, 44, may help to solubilize the polyamide or polyamide elastomer particles at the surfaces 46, 48. The solubilized particles may dissolve and blend together to form an ultra-strong weld that bonds the two 3D objects 42, 44.

The resulting 3D printed article 54 includes the first polyamide-based 3D object 42 and the second polyamide-based 3D object 44 solvent welded with benzyl alcohol 50 to the polyamide-based 3D object 42, where the second polyamide-based has a different chemical composition than the first polyamide-based 3D object.

As the objects 42, 44 are solvent and heat welded, the contacting surfaces 46, 48 of the polyamide-based 3D object 42 and the second polyamide-based 3D object 44 are free of an adhesive.

In one example, the first polyamide-based 3D object 42 is an orthotic; and the second polyamide-based 3D object 44 is an insole or a top cover for the orthotic.

To further illustrate the present disclosure, an example is given herein. It is to be understood that this example is provided for illustrative purposes and is not to be construed as limiting the scope of the present disclosure.

### Example

A base was 3D printed in accordance with the example set forth herein using polyamide-12 as the build material composition and a carbon black based fusing agent.

A midsole for the base was 3D printed in accordance with the example set forth herein using a poly(ether amide) block copolymer as the build material composition and a carbon black based fusing agent.

Benzyl alcohol was applied to a top surface of the base and a bottom surface of the midsole using a brush. The surfaces were brought into contact, and the in-contact 3D printed objects were placed into an oven set at 150° C. for about 2 hours.

This temperature was selected because it is lower than the melting point of polyamide 12 and is also lower than the lowest temperature in the melting temperature of the polyamide elastomer. After heating, the welded 3D printed objects were removed from the oven and allowed to cool.

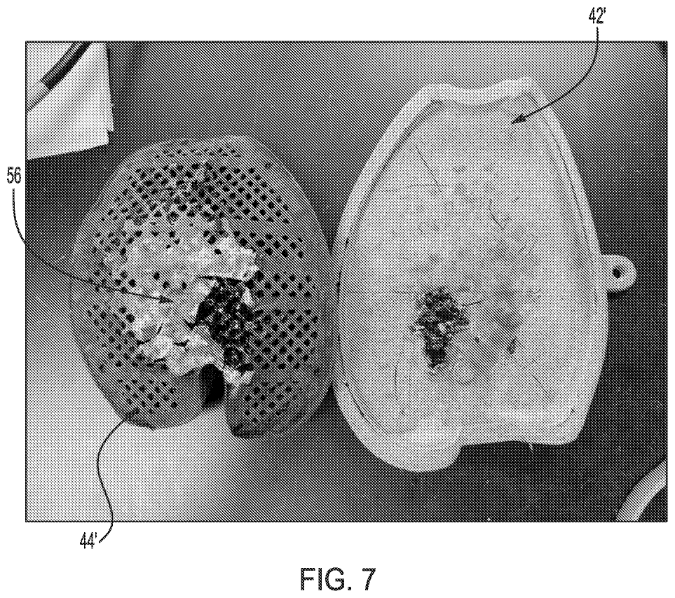

The strength of the weld between the 3D printed objects was tested manually. An attempt to separate the midsole from the base was performed by pulling the midsole and the base in opposite directions. The midsole was not able to be separated from the base with pulling alone. An additional attempt to separate the midsole from the base was performed by repetitively inserting a razor into the interface between the two 3D printed objects simultaneously with pulling the midsole from the base using excessive force. With the aid of the razor, the midsole was able to be removed. FIG. 7 illustrates a photograph, reproduced in black and white, of the top surface of the base 42′ (right side of FIG. 7) and the bottom surface of the midsole 44′ (left side of FIG. 7). As illustrated, a portion 56 of the base was removed with the midsole in order to achieve the separation. This suggests that the strength of the weld between the 3D printed objects (and thus the two different polyamide-based materials was higher than the strength of the polyamide 12 layers fused together during the 3D printing process.

It is to be understood that the ranges provided herein include the stated range and any value or sub-range within the stated range. For example, from about 0.01 wt % to about 5 wt % should be interpreted to include not only the explicitly recited limits of from about 0.01 wt % to about 5 wt %, but also to include individual values, such as about 0.25 wt %, about 0.55 wt %, about 1.74 wt %, about 2.03 wt %, about 3.2 wt %, about 5.5 wt %, etc., and sub-ranges, such as from about 0.2 wt % to about 4.8 wt %, from about 1 wt % to about 2 wt %, from about 0.05 wt % to about 3.75 wt %, etc.

Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A method, comprising:
applying benzyl alcohol to a surface of a first polyamide-based 3D object, a surface of a second polyamide-based 3D object, or both the surface of the first polyamide-based 3D object and the surface of the second polyamide-based 3D object, wherein each of the first polyamide-based 3D object and the second polyamide-based 3D object is independently selected from the group consisting of a polyamide 3D object and a polyamide elastomer 3D object, and wherein the first polyamide-based 3D object has a different chemical composition than the second polyamide-based 3D object;
after the benzyl alcohol is applied, directly contacting the surface of the first polyamide-based 3D object with the surface of the second polyamide-based 3D object; and
while the surfaces are in contact, exposing the first polyamide-based 3D object and the second polyamide-based 3D object to a predetermined temperature for a predetermined time, thereby welding the surfaces together.

2. The method as defined in claim 1, wherein:
the first polyamide-based 3D object is the polyamide 3D object;
the polyamide 3D object includes a coalesced polyamide material selected from the group consisting of polyamide 12, polyamide 11, polyamide 6, polyamide 8, polyamide 9, polyamide 66, polyamide 612, polyamide 812, and polyamide 912;
the second polyamide-based 3D object is the polyamide elastomer 3D object; and
the polyamide elastomer 3D object includes a coalesced polyamide elastomer material selected from the group consisting of a poly(ester amide) block copolymer, a poly(ether ester amide) block copolymer, and a poly(ether amide) block copolymer.

3. The method as defined in claim 1, wherein:
the first polyamide-based 3D object is the polyamide 3D object;
the polyamide 3D object includes coalesced polyamide 12;
the second polyamide-based 3D object is a second polyamide 3D object; and
the second polyamide 3D object includes a coalesced polyamide material selected from the group consisting of polyamide 11, polyamide 6, polyamide 8, polyamide 9, polyamide 66, polyamide 612, polyamide 812, and polyamide 912.

4. The method as defined in claim 1, wherein the predetermined temperature is below a melting temperature of each of the first polyamide-based 3D object and the second polyamide-based 3D object.

5. The method as defined in claim 4, wherein the predetermined temperature ranges from about 50° C. to about 150° C.

6. The method as defined in claim 1, further comprising determining the predetermined time based on a geometry of each of the first polyamide-based 3D object and the second polyamide-based 3D object.

7. The method as defined in claim 6, wherein the predetermined time ranges from about 1 minute to about 24 hours.

8. The method as defined in claim 1, wherein the benzyl alcohol is applied by brushing, dripping, or spraying.

9. The method as defined in claim 1, wherein:
the first polyamide-based 3D object is the polyamide elastomer 3D object;
the polyamide elastomer 3D object includes a coalesced polyamide elastomer material selected from the group consisting of a poly(ester amide) block copolymer, a poly(ether ester amide) block copolymer, and a poly(ether amide) block copolymer;
the second polyamide-based 3D object is a second polyamide elastomer 3D object; and
the second polyamide elastomer 3D object includes a coalesced polyamide elastomer material that is different from the coalesced polyamide elastomer material polyamide elastomer 3D object.

10. A method, comprising:
generating a polyamide-based 3D object by:
iteratively applying a polyamide-based build material composition to form respective build material layers;
based on a digital 3D object model of the polyamide-based 3D object, selectively applying a fusing agent on at least a portion of each of the respective build material layers to define individually patterned layers; and
iteratively exposing the individually patterned layers to electromagnetic radiation to form individual object layers; and
solvent welding the polyamide-based 3D object to a second polyamide-based 3D object by:
applying benzyl alcohol to a surface of the polyamide-based 3D object, a surface of the second polyamide-based 3D object, or both the surface of the polyamide-based 3D object and the surface of the second polyamide-based 3D object, wherein the second polyamide-based 3D object is a second polyamide-based 3D object having a different chemical composition than the polyamide-based 3D object;
after the benzyl alcohol is applied, directly contacting the surface of the polyamide-based 3D object with the surface of the second polyamide-based 3D object; and
while the surfaces are in contact, exposing the polyamide-based 3D object and the second polyamide-based 3D object to a predetermined temperature for a predetermined time, thereby welding the surfaces together.

11. The method as defined in claim 10, wherein the polyamide-based build material composition includes a polyamide material selected from the group consisting of polyamide 12, polyamide 11, polyamide 6, polyamide 8, polyamide 9, polyamide 66, polyamide 612, polyamide 812, and polyamide 912.

12. The method as defined in claim 11, wherein:
i) the second polyamide-based 3D object is a polyamide elastomer 3D object; and
the polyamide elastomer 3D object includes a coalesced polyamide elastomer material selected from the group consisting of a poly(ester amide) block copolymer, a poly(ether ester amide) block copolymer, and a poly(ether amide) block copolymer; or
ii) the second polyamide-based 3D object is a polyamide 3D object; and
the second polyamide-based 3D object includes a different coalesced polyamide material than the polyamide-based 3D object.

13. The method as defined in claim 10, wherein:
the predetermined temperature ranges from about 50° C. to about 150° C.; and
the predetermined time ranges from about 10 minutes to about 24 hours.

14. A 3D printed article, comprising:
a polyamide-based 3D object; and
a second polyamide-based 3D object solvent welded with benzyl alcohol to the polyamide-based 3D object, the second polyamide-based 3D object having a different chemical composition than the polyamide-based 3D object.

15. The 3D printed article as defined in claim 14, wherein:
the polyamide-based 3D object is an orthotic; and
the second polyamide-based 3D object is an insole or a top cover for the orthotic.
